(19) United States
(12) Patent Application Publication
(10) Pub. No.: US 2008/0249160 A1
(43) Pub. Date: Oct. 9, 2008

(54) Nematicidal Fatty Acid and Fatty Acid Ester Related Compounds

(76) Inventors: Deryck J. Williams, St. Louis, MO (US); Andrew P. Kloek, San Francisco, CA (US); Michelle Coutu Hresko, Chesterfield, MO (US); Barry J. Shortt, New Melle, MO (US); Jennifer A. Davila-Aponte, St. Louis, MO (US); John D. Bradley, St. Louis, MO (US); James McCarter, St. Louis, MO (US); Merry B. McLaird, Kirkwood, MO (US)

Correspondence Address: FISH & RICHARDSON PC, P.O. BOX 1022, MINNEAPOLIS, MN, 55440-1022, US

(21) Appl. No.: 12/105,591

(22) Filed: Apr. 18, 2008

Related U.S. Application Data
(63) Continuation of application No. 10/655,165, filed on Sep. 4, 2003, now abandoned.
Application No. 10/655,165 is a continuation-in-part of application No. 10/187,683, filed on Jul. 1, 2002, now Pat. No. 6,903,052.
Application No. 10/187,683 is a continuation-in-part of application No. 10/090,527, filed on Mar. 4, 2002, now Pat. No. 6,887,900.

(30) Foreign Application Priority Data
Mar. 4, 2003 (US) PCT/US03/06525

(51) Int. Cl. A01N 43/20; A01N 37/06; A01P 5/00

(52) U.S. Cl. 514/449; 514/560; 514/475

(57) ABSTRACT

Certain fatty acids and related compounds useful in the control nematodes that infest plants or the situs of plants are described. Nematodes that parasitize animals can also be controlled using the methods and compounds of this invention.

### RELATED APPLICATION INFORMATION

This application is a continuation-in-part of U.S. application Ser. No. 10/187,683, filed Jul. 1, 2002, which is a continuation-in-part of U.S. application Ser. No. 10/090,527, filed Mar. 4, 2002, and also claims priority to PCT/US03/06525, filed Mar. 4, 2003, all of which are herein incorporated by reference.

### BACKGROUND

Nematodes (derived from the Greek word for thread) are active, flexible, elongate, organisms that live on moist surfaces or in liquid environments, including films of water within soil and moist tissues within other organisms. While only 20,000 species of nematode have been identified, it is estimated that 40,000 to 10 million actually exist. Some species of nematodes have evolved to be very successful parasites of both plants and animals and are responsible for significant economic losses in agriculture and livestock and for morbidity and mortality in humans (Whitehead (1998) Plant Nematode Control. CAB International, New York).

Nematode parasites of plants can inhabit all parts of plants, including roots, developing flower buds, leaves, and stems. Plant parasites are classified on the basis of their feeding habits into the broad categories: migratory ectoparasites, migratory endoparasites, and sedentary endoparasites. Sedentary endoparasites, which include the root knot nematodes (Meloidogyne) and cyst nematodes (Globodera and Heterodera) induce feeding sites and establish long-term infections within roots that are often very damaging to crops (Whitehead, supra). It is estimated that parasitic nematodes cost the horticulture and agriculture industries in excess of $78 billion worldwide a year, based on an estimated average 12% annual loss spread across all major crops. For example, it is estimated that nematodes cause soybean losses of approximately $3.2 billion annually worldwide (Barker et al. (1994) Plant and Soil Nematodes: Societal Impact and Focus for the Future. The Committee on National Needs and Priorities in Nematology. Cooperative State Research Service, US Department of Agriculture and Society of Nematologists). Several factors make the need for safe and effective nematode controls urgent. Continuing population growth, famines, and environmental degradation have heightened concern for the sustainability of agriculture, and new government regulations may prevent or severely restrict the use of many available agricultural anthelmintic agents.

There are a very small array of chemicals available to control nematodes (Becker (1999) Agricultural Research Magazine 47(3):22-24; U.S. Pat. No. 6,048,714). Nevertheless, the application of chemical nematicides remains the major means of nematode control. In general, chemical nematicides are highly toxic compounds known to cause substantial environmental impact and are increasingly restricted in the amounts and locations in which then can be used. For example, the soil fumigant methyl bromide which has been used effectively to reduce nematode infestations in a variety of specialty crops, is regulated under the U.N. Montreal Protocol as an ozone-depleting substance and is scheduled for elimination in 2005 in the US (Carter (2001) California Agriculture, 55(3):2). It is expected that strawberry and other commodity crop industries will be significantly impacted if a suitable replacement for methyl bromide is not found. Similarly, broad-spectrum nematicides such as Telone (various formulations of 1,3-dichloropropene) have significant restrictions on their use because of toxicological concerns (Carter (2001) California Agriculture, Vol. 55(3):12-18).

The macrocyclic lactones (e.g., avermectins and milbemycins) and delta-toxins from Bacillus thuringiensis (Br) are chemicals that in principle provide excellent specificity and efficacy and should allow environmentally safe control of plant parasitic nematodes. Unfortunately, in practice, these two nematicidal agents have proven less effective in agricultural applications against root pathogens. Although certain avermectins show exquisite activity against plant parasitic nematodes these chemicals are hampered by poor bioavailability due to their light sensitivity, degradation by soil microorganisms and tight binding to soil particles (Lasota & Dybas (1990) Acta Leiden 59(1-2):217-225; Wright & Perry (1998) Musculature and Neurobiology. In: The Physiology and Biochemistry of Free-Living and Plant-parasitic Nematodes (eds R. N. Perry & D. J. Wright), CAB International 1998). Consequently despite years of research and extensive use against animal parasitic nematodes, mites and insects (plant and animal applications), macrocyclic lactones (e.g., avermectins and milbemycins) have never been commercially developed to control plant parasitic nematodes in the soil.

Bt delta toxins must be ingested to affect their target organ, the brush border of midgut epithelial cells (Marroquin et al. (2000) Genetics. 155(4):1693-1699). Consequently they are not anticipated to be effective against the dispersal, non-feeding, juvenile stages of plant parasitic nematodes in the field. Because juvenile stages only commence feeding when a susceptible host has been infected, nematicides may need to penetrate the plant cuticle to be effective. Transcuticular uptake of a 65-130 kDa protein—the size of typical Bt delta ends toxins—is unlikely. Furthermore, soil mobility is expected to be relatively poor. Even transgenic approaches are hampered by the size of Bt delta toxins because delivery in planta is likely to be constrained by the exclusion of large particles by the feeding tubes of certain plant parasitic nematodes such as Heterodera (Atkinson et al. (1998) Engineering resistance to plant-parasitic nematodes. In: The Physiology and Biochemistry of Free-Living and Plant-parasitic Nematodes (eds R. N. Perry & D. J. Wright), CAB International 1998).

Fatty acids are a class of natural compounds that have been investigated as alternatives to the toxic, non-specific organophosphate, carbamate and fumigant pesticides (Stadler et al. (1994) Planta Medica 60(2):128-132; U.S. Pat. Nos. 5,192,546; 5,346,698; 5,674,897; 5,698,592; 6,124,359). It has been suggested that fatty acids derive their pesticidal effects by adversely interfering with the nematode cuticle or hypodermis via a detergent (solubilization) effect, or through direct interaction of the fatty acids and the lipophilic regions of target plasma membranes (Davis et al. (1997) Journal of Nematology 29(4S):677-684). In view of this predicted mode of action it is not surprising that fatty acids are used in a variety of pesticidal applications including as herbicides (e.g., SCYTHE by Dow Agrosciences is the C9 saturated fatty acid pelargonic acid), bactericides and fungicides (U.S. Pat. Nos. 4,771,571; 5,246,716) and insecticides (e.g., SAFER INSECTICIDAL SOAP by Safer, Inc.).

The phytotoxicity of fatty acids has been a major constraint on their general use in post-plant agricultural applications (U.S. Pat. No. 5,093,124) and the mitigation of these undesirable effects while preserving pesticidal activity is a major area of research. Post-plant applications are desirable because of the relatively short half-life of fatty acids under field conditions.

The esterification of fatty acids can significantly decrease their phytotoxicity (U.S. Pat. Nos. 5,674,897; 5,698,592; 6,124,359). Such modifications can however lead to loss of nematicidal activity as is seen for linoleic, linolenic and oleic acid (Stadler et al. (1994) Planta Medica 60(2):128-132) and it may be impossible to completely decouple the phytotoxicity and nematicidal activity of pesticidal fatty acids because of their non-specific mode of action. Perhaps not surprisingly, the nematicidal fatty acid pelargonic acid methyl ester (U.S. Pat. Nos. 5,674,897; 5,698,592; 6,124,359) shows a relatively small “therapeutic window” between the onset of pesticidal activity and the observation of significant phytotoxicity (Davis et al. (1997) J Nematol 29(4S):677-684). This is the expected result if both the phytotoxicity and the nematicidial activity derive from the non-specific disruption of plasma membrane integrity.

Ricinoleic acid, the major component of castor oil, has been shown to have an inhibitory effect on water and electrolyte absorption using everted hamster jejunal and ileal segments (Gaginella et al. (1975) J Pharmacol Exp Ther 195(2):355-61) and to be cytotoxic to isolated intestinal epithelial cells (Gaginella et al. (1977) J Pharmacol Exp Ther 201(1):259-66). These features are likely the source of the laxative properties of castor oil which is given as a purgative in humans and livestock (e.g., castor oil is a component of some de-worming protocols because of its laxative properties). In contrast, the methyl ester of ricinoleic acid is ineffective at suppressing water absorption in the hamster model (Gaginella et al. (1975) J Pharmacol Exp Ther 195(2):355-61).

It has been reported that short- and medium-chain fatty acids and salts (e.g., C6 to C12) have superior fungicidal activity (U.S. Pat. Nos. 5,093,124 and 5,246,716). Not surprisingly, the commercial fungicidal and moss killing product De-Moss comprises mainly fatty acids and salts in this size range. The phytotoxicity of these shorter fatty acids also makes them suitable as broad-spectrum herbicides when used at higher concentrations as is exemplified by the commercial herbicide SCYTHE which comprises the C9 fatty acid pelargonic (nonanoic) acid. U.S. Pat. Nos. 5,093,124, 5,192,546, 5,246,716 and 5,346,698 teach that C16 to C20 fatty acids and salts such as oleic acid (C18:1) are suitable insecticidal fatty acids. Insecticidal fatty acid products such as M-PEDE and SAFER Insecticidal Concentrate whose active ingredients comprise longer chain fatty acids rich in C16 and C18 components represent real world applications of this scientific information. In contrast, the prior art provides little guidance for the selection of suitable broad-spectrum nematicidal fatty acids and what information exists is often contradictory.

Stadler and colleagues (Stadler et al. (1994) Planta Medica 60(2):128-132) tested a series of fatty acids against L4 and adult C. elegans stages and found that a number of common longer chain fatty acids such as linoleic (C18:2), myristic (C14:0), palmitoleic (C16:1) and oleic (C18:1) acids had significant nematicidal activity. C. elegans was not very sensitive to C6 to C10 (medium chain) fatty acids. Stadler et al. commented that their results contrasted with those of an earlier study on the plant parasite Aphelenchoides besseyi where C8 to C12 fatty acids were found to be highly active while linoleic acid—a C18 fatty acid—showed no activity. The differential sensitivity of specific nematodes to various fatty acids is again evident in the study of Djian and co-workers (Djian et al. (1994) Pestic. Biochem. Physiol. 50(3):229-239) who demonstrate that the nematicidal potency of short volatile fatty acids such as pentanoic acid can vary between species (e.g., Meloidogyne incognita is over a hundred times more sensitive than Panagrellus redivivus). The recent finding by Momin and Nair (Momin & Nair (2002) J. Agric. Food Chem. 50(16):4475-4478) that oleic acid at 100 μg/ml over 24 hours is not nematicidal to either Panagrellus redivivus or Caenorhabditis elegans further confuses the situation as it directly conflicts with the LD50 of 25 μg/ml (LD90 100 μg/ml) measured by Stadler and coworkers.

In summary, unlike the case for fungicides, herbicides and insecticides, the prior art provides no specific or credible guidance to aid in the selection of suitable nematicidal fatty acids. Moreover, whereas De-Moss, SCYTHE, M-PEDE and SAFER, are examples of successful pesticidal fatty acid products in these three areas respectively, there are currently no examples of commercial nematicidal fatty acid products in widespread use.

Many plant species are known to be highly resistant to nematodes. The best documented of these include marigolds (Tagetes spp.), rattlebox (Crotalaria spectabilis), chrysanthemums (Chrysanthemum spp.), castor bean (Ricinus communis), margosa (Azardiracta indica), and many members of the family Asteraceae (family Conmpositae) (Hackney & Dickerson. (1975) J Nematol 7(1):84-90). In the case of the Asteraceae, the photodynamic compound alpha-terthienyl has been shown to account for the strong nematicidal activity of the roots. Castor beans are plowed under as a green manure before a seed crop is set. However, a significant drawback of the castor plant is that the seed contains toxic compounds (such as ricin) that can kill humans, pets, and livestock and is also highly allergenic. In many cases however, the active principle(s) for plant nematicidal activity has not been discovered and it remains difficult to derive commercially successful nematicidal products from these resistant plants or to transfer the resistance to agronomically important crops such as soybeans and cotton.

Genetic resistance to certain nematodes is available in some commercial cultivars (e.g., soybeans), but these are restricted in number and the availability of cultivars with both desirable agronomic features and resistance is limited. The production of nematode resistant commercial varieties by conventional plant breeding based on genetic recombination through sexual crosses is a slow process and is often further hampered by a lack of appropriate germplasm.

There remains an urgent need to develop environmentally safe, target-specific ways of controlling plant parasitic nematodes. In the specialty crop markets, economic hardship resulting from nematode infestation is highest in strawberries, bananas, and other high value vegetables and fruits. In the high-acreage crop markets, nematode damage is greatest in soybeans and cotton. There are however, dozens of additional crops that suffer from nematode infestation including potato, pepper, onion, citrus, coffee, sugarcane, greenhouse ornamentals and golf course turf grasses.

Nematode parasites of vertebrates (e.g., humans, livestock and companion animals) include gut roundworms, hookworms, pinworms, whipworms, and filarial worms. They can be transmitted in a variety of ways, including by water contamination, skin penetration, biting insects, or by ingestion of contaminated food.

In domesticated animals, nematode control or “de-worming” is essential to the economic viability of livestock producers and is a necessary part of veterinary care of companion animals. Parasitic nematodes cause mortality in animals (e.g., heartworm in dogs and cats) and morbidity as a result of the parasites' inhibiting the ability of the infected animal to absorb nutrients. The parasite-induced nutrient deficiency leads to disease and stunted growth in livestock and companion animals. For instance, in cattle and dairy herds, a single untreated infection with the brown stomach worm can permanently restrict an animal's ability to convert feed into muscle mass or milk.

Two factors contribute to the need for novel anthelmintics and vaccines for control of parasitic nematodes of animals. First, some of the more prevalent species of parasitic nematodes of livestock are building resistance to the anthelmintic drugs available currently, meaning that these products will eventually lose their efficacy. These developments are not surprising because few effective anthelmintic drugs are available and most have been used continuously. Some parasitic species have developed resistance to most of the anthelmintics (Geents et al. (1997) Parasitology Today 13:149-151; Prichard (1994) Veterinary Parasitology 54:259-268). The fact that many of the anthelmintic drugs have similar modes of action complicates matters, as the loss of sensitivity of the parasite to one drug is often accompanied by side resistance—that is, resistance to other drugs in the same class (Sangster & Gill (1999) Parasitology Today 15(4):141-146). Secondly, there are some issues with toxicity for the major compounds currently available.

Infections by parasitic nematode worms result in substantial human mortality and morbidity, especially in tropical regions of Africa, Asia, and the Americas. The World Health Organization estimates 2.9 billion people are infected, and in some areas, 85% of the population carries worms. While mortality is rare in proportion to infections, morbidity is substantial and rivals diabetes and lung cancer in worldwide disability adjusted life year (DALY) measurements.

Examples of human parasitic nematodes include hookworms, filarial worms, and pinworms. Hookworms (1.3 billion infections) are the major cause of anemia in millions of children, resulting in growth retardation and impaired cognitive development. Filarial worm species invade the lymphatics, resulting in permanently swollen and deformed limbs (elephantiasis), and the eyes, causing African river blindness. The large gut roundworm Ascaris lumbricoides infects more than one billion people worldwide and causes malnutrition and obstructive bowel disease. In developed countries, pinworms are common and often transmitted through children in daycare.

Even in asymptomatic parasitic infections, nematodes can still deprive the host of valuable nutrients and increase the ability of other organisms to establish secondary infections. In some cases, infections can cause debilitating illnesses and can result in anemia, diarrhea, dehydration, loss of appetite, or death.

Despite some advances in drug availability and public health infrastructure and the near elimination of one tropical nematode (the water-borne Guinea worm), most nematode diseases have remained intractable problems. Treatment of hookworm diseases with anthelmintic drugs, for instance, has not provided adequate control in regions of high incidence because rapid re-infection occurs after treatment. In fact, over the last 50 years, while nematode infection rates have fallen in the United States, Europe, and Japan, the overall number of infections worldwide has kept pace with the growing world population. Large scale initiatives by regional governments, the World Health Organization, foundations, and pharmaceutical companies are now underway attempting to control nematode infections with currently available tools, including three programs for control of Onchocerciasis (river blindness) in Africa and the Americas using ivermectin and vector control; The Global Alliance to Eliminate Lymphatic Filariasis using DEC, albendazole, and ivermectin; and the highly successful Guinea Worm Eradication Program. Until safe and effective vaccines are discovered to prevent parasitic nematode infections, anthelmintic drugs will continue to be used to control and treat nematode parasitic infections in both humans and domestic animals.

Finding effective compounds and vaccines against parasitic nematodes has been complicated by the fact that the parasites have not been amenable to culturing in the laboratory. Parasitic nematodes are often obligate parasites (i.e., they can only survive in their respective hosts, such as in plants, animals, and/or humans) with slow generation times. Thus, they are difficult to grow under artificial conditions, making genetic and molecular experimentation difficult or impossible. To circumvent these limitations, scientists have used Caenorhabidits elegans as a model system for parasitic nematode discovery efforts.

C. elegans is a small free-living bacteriovorous nematode that for many years has served as an important model system for multicellular animals (Burglin (1998) Int. J. Parasitol. 28(3):395-411). The genome of C. elegans has been completely sequenced and the nematode shares many general developmental and basic cellular processes with vertebrates (Ruvkin et al. (1998) Science 282:2033-41). This, together with its short generation time and ease of culturing, has made it a model system of choice for higher eukaryotes (Aboobaker et al. (2000) Ann. Med. 32:23-30).

Although C. elegans serves as a good model system for vertebrates, it is an even better model for study of parasitic nematodes, as C. elegans and other nematodes share unique biological processes not found in vertebrates. For example, unlike vertebrates, nematodes produce and use chitin, have gap junctions comprised of innexin rather than connexin and contain glutamate-gated chloride channels rather than glycine-gated chloride channels (Bargmann (1998) Science 282:2028-33). The latter property is of particular relevance given that the avermectin class of drugs is thought to act at glutamate-gated chloride receptors and is highly selective for invertebrates (Martin (1997) Vet. J. 154:11-34).

A subset of the genes involved in nematode-specific processes will be conserved in nematodes and absent or significantly diverged from homologues in other phyla. In other words, it is expected that at least some of the genes associated with functions unique to nematodes will have restricted phylogenetic distributions. The completion of the C. elegans genome project and the growing database of expressed sequence tags (ESTs) from numerous nematodes facilitate identification of these “nematode-specific” genes. In addition, conserved genes involved in nematode-specific processes are expected to retain the same or very similar functions in different nematodes. This functional equivalence has been demonstrated in some cases by transforming C. elegans with homologous genes from other nematodes (Kwa et al. (1995) J. Mol. Biol. 246:500-10; Redmond et al. (2001) Mol. Biochem. Parasitol. 112:125-131). This sort of data transfer has been shown in cross phyla comparisons for conserved genes and is expected to be more robust among species within a phylum. Consequently, C. elegans and other free-living nematode species are likely excellent surrogates for parasitic nematodes with respect to conserved nematode processes.

Many expressed genes in C. elegans and certain genes in other free-living nematodes can be “knocked out” genetically by a process referred to as RNA interference (RNAi), a technique that provides a powerful experimental tool for the study of gene function in nematodes (Fire et al. (1998) Nature 391(6669):806-811; Montgomery et al. (1998) Proc. Natl. Acad Sci USA 95(26):15502-15507). Treatment of a nematode with double-stranded RNA of a selected gene can destroy expressed sequences corresponding to the selected gene thus reducing expression of the corresponding protein. By preventing the translation of specific proteins, their functional significance and essentiality to the nematode can be assessed. Determination of essential genes and their corresponding proteins using C. elegans as a model system will assist in the rational design of anti-parasitic nematode control products.

The present invention describes compositions which shows surprising nematicidal activity in part due to selective inhibition of metabolic processes demonstrated to be essential to nematodes and either absent or non-essential in vertebrates and plants. This invention therefore provides urgently needed compounds and methods for the environmentally safe control of parasitic nematodes.

### SUMMARY

The invention concerns compositions and processes for controlling nematodes. In one embodiment, the subject invention comprises the use of certain fatty acids, fatty acid esters and related compounds (e.g., related amides, aldehydes and ketones) to control nematodes that infest plants or the situs of plants. Nematodes that parasitize animals can also be controlled using the methods and compounds of this invention.

Certain of the useful nematicidal fatty acids (free fatty acids and salts) and analogs (e.g., esters, amides, aldehydes and ketones) are predicted inhibitors of nematode delta-12 fatty acid desaturases (also referred to herein as a nematode delta-12 desaturases). These useful fatty acids and analogs can be, for example, an epoxide, a cyclopropane, a cyclopropene, an oxo, methylated, or hydroxylated fatty acid or analog. The compounds can also contain sulfur in place of carbon at certain positions. In certain embodiments of the invention the fatty acids and analogs are delta-12 desaturase inhibiting fatty acids, esters, amides, aldehydes and ketones. The term fatty acid analog is also used to denote free fatty acids, fatty acid salts, fatty acid esters, fatty acid amides, fatty acid aldehydes and fatty acid ketones of fatty acids having modified carbon chains (e.g., those containing for example, epoxide, cyclopropane, cyclopropene, oxo, hydroxy, conjugated double bonds, triple bonds or other unusual groups in the fatty acid carbon chain).

Certain fatty acids, esters, amides, aldehydes and ketones useful according to the subject invention are C16 to C20 in length (i.e., have a carbon chain that has 16, 17, 18, 19 or 20 carbons, including the carbonyl carbon), have a cis (Z) or a trans (E) carbon double bond at the delta-9 position (i.e., between C9 and C10 counting from the carbonyl carbon (C═O)) and a variety of modifications at the C12, C13 or both C12 and C13 positions. Fatty acid analogs also include thia fatty acid analogs with sulfur in place of carbon at positions 12, 13 or 12 and 13. In certain embodiments, the carbon chain is C16 to C18 in length (including the carbonyl carbon). Examples include, ricinoleic (12-hydroxy-cis-9-octadecenoic) acid and its corresponding methyl ester, amide, methyl amide, aldehyde and methyl ketone analogs, ricinelaidic (12-hydroxy-trans-9-octadecenoic) acid and its corresponding methyl ester, amide, methyl amide, aldehyde and methyl ketone analogs, vernolic ((12,13)-epoxy-cis-9-octadecenoic) acid and its corresponding methyl ester, amide, methyl amide, aldehyde and methyl ketone analogs, (12,13)-epoxy-trans-9-octadecenoic acid and its corresponding methyl ester, amide, methyl amide, aldehyde and methyl ketone analogs, 12-oxo-9(Z)-octadecenoic acid and its corresponding methyl ester, amide, methyl amide, aldehyde and methyl ketone analogs, 12-oxo-9(E)-octadecenoic acid and its corresponding methyl ester, amide, methyl amide, aldehyde and methyl ketone analogs. Specifically excluded are the normal substrates of delta-12 desaturases (e.g., cis-9-octadecenoate (oleate), cis-9-hexadecenoate (palmitoleate), isomers of the substrate such as trans-9-octadecenoate (elaidate) and the normal products of delta-12 desaturases (e.g., cis-9,12-octadecadienoate (linoleate), cis-9,12-hexadecadienoate). Fatty acid compounds where the only modifications are a single cis or trans double bond at the delta-9 position (i.e., a cis or trans double bond between C9 and C10), or double bonds at both the delta-9 (cis or trans double bond between C9 and C10) and delta-12 positions (i.e., a cis or trans double bond between C12 and C13) as well as certain naturally occurring esters such as triglycerides, diacylglycerides and phospholipids are generally less preferred. Examples of sulfur containing fatty acid analogs include methyl 12-thia-oleate and methyl 13-thia-oleate.

Fatty acids analogs (e.g., free fatty acids, salts, esters, amides, aldehydes and ketones) that have the characteristics of a specific inhibitor of delta-12 desaturase inhibit the activity of a nematode delta-12 desaturase to a lesser extent in the presence of the product of a delta-12 fatty acid desaturase (e.g., linoleate) than in the presence of the substrate of the enzyme (e.g., oleate). For these competition experiments the substrate (e.g., oleate) and the product (e.g., linoleate) are used in equivalent amounts. These effects can be demonstrated on a delta-12 fatty acid desaturase (also referred to herein as a delta-12 desaturase) protein in vitro, on transgenic cells containing delta-12 desaturases or on intact organisms (e.g., a nematode) containing delta-12 desaturases. In one embodiment of this test, the inhibitor, the substrate and product of the delta-12 desaturase are present in equal concentrations.

The invention also features compounds that inhibit the expression of a delta-12 desaturase at the level of transcription or translation. Also within the invention are compounds that that impair the modification of a delta-12 desaturase resulting in change in the activity or localization of the desaturase.

The invention also features compounds that are relatively selective inhibitors of one or more nematode delta-12 desaturase polypeptides relative to one or more plant or animal fatty acid desaturase-like polypeptides. The compounds can have a Kᵢ for a nematode fatty acid desaturase that is 10-fold, 100-fold, 1,000-fold or more lower than for a plant or animal fatty acid desaturase-like polypeptides, e.g., a host plant or host animal of the nematode. The invention further features relatively non-selective inhibitors as well as completely non-selective inhibitors.

In yet another aspect, the invention features a method of treating a disorder (e.g., an infection) caused by a nematode, (e.g., M. incognita, H. glycines, H. contortus, A. suum) in a subject, e.g., a host plant or host animal. The method includes administering to the subject an effective amount of a fatty acid (free fatty acids or salts) or fatty acid analog (ester, amide, aldehyde or ketone) of the invention, e.g., a compound that is an inhibitor of a delta-12 desaturase polypeptide activity or an inhibitor of expression of a delta-12 desaturase polypeptide or an inhibitor that impairs the modification of a delta-12 desaturase resulting in change in the activity or localization of the desaturase. The inhibitor may be delivered by several means including as a feed additive, as a pill or by injection.

In still another aspect, methods of inhibiting a nematode (e.g., M. incognita, H. glycines, H. contortus, A. suum) delta-12 desaturase(s) are provided. Such methods can include the steps of: (a) providing a nematode, e.g., a nematode that contains a delta-12 fatty acid desaturase-like gene; (b) contacting the nematode with a fatty acid (free fatty acids or salts) or fatty acid analog of the invention. Certain such compounds may inhibit the activity of a delta-12 desaturase. Also provided are methods of rescuing the effect of the inhibitor. Such methods comprise the steps of: (a) inhibiting the enzyme and (b) providing delta-12 unsaturated fatty acids exogenously (e.g., linoleate).

In another aspect, methods of reducing the viability or fecundity or slowing the growth or development or inhibiting the infectivity of a nematode using a nematicidal fatty acid or fatty acid analog of the invention, e.g., an inhibitor of a delta-12 desaturase are provided. Such methods comprise the steps of (a) providing a nematode that contains a delta-12 desaturase-like gene; (b) contacting the nematode with specific fatty acid or fatty acid analog, e.g., an inhibitor of a delta-12 fatty acid desaturase; (c) reducing the viability or fecundity of the nematode. Also provided are methods of rescuing the effect of the fatty acid desaturase inhibitors or other inhibitors. Such methods can involve contacting the nematode with delta-12 unsaturated fatty acids exogenously.

The invention features a method for reducing the viability, growth, or fecundity of a nematode, the method comprising exposing the nematode to a fatty acid or fatty acid analog of the invention, e.g., a compound that inhibits the activity of a fatty acid desaturase-like polypeptide (e.g., a delta-12 fatty acid desaturase) and a method for protecting a plant from a nematode infection, the method comprising applying to the plant, to the soil, or to seeds of the plant a fatty acid or fatty acid analog of the invention.

The invention also features a method for protecting a vertebrate (e.g., a bird or a mammal) from a nematode infection, the method comprising administering to the vertebrate a fatty acid or fatty acid analog of the invention, e.g., an inhibitor of a nematode fatty acid desaturase-like polypeptide (e.g., a delta-12 fatty acid desaturase). In preferred embodiments the inhibitor does not significantly inhibit the activity of a fatty acid desaturase-like polypeptide expressed by the vertebrate or at least does not do so to the extent that the growth of the vertebrate is significantly impaired. The bird can be a domesticated fowl (e.g., a chicken, turkey, duck, or goose). The mammal can be a domesticated animal, e.g., a companion animal (e.g., a cat, dog, or rabbit) or livestock (e.g., a cow, sheep, horse, pig, goat, alpaca, or llama).

The invention process is particularly valuable to control nematodes attacking the roots of desired crop plants, ornamental plants, and turf grasses. The desired crop plants can be, for example, soybeans, cotton, strawberries, tomatoes, banana, sugar cane, sugar beet, potatoes, or citrus.

In one aspect the invention features a nematicidal composition comprising:

(a) an effective amount of a compound having the formula

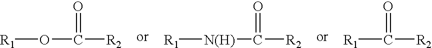

wherein:

R₁═H, a cation (e.g., Na⁺, K⁺, NH₄⁺) or a C1-C5 (i.e., a one, two, three, four or five carbon) substituted or unsubstituted carbon chain (e.g., a straight chain), wherein the substituents are selected from the group consisting of: hydroxy, halogen, amino, cyano, cyclopropane, epoxy and a substituted or unsubstituted C1-C2 (i.e., a one or two carbon) carbon chain; and

R₂=a C15-C19 (i.e., a 15, 16, 17, 18, or 19 carbon) substituted or unsubstituted carbon chain (e.g., a straight chain) having a cis or trans double bond between the 9^{th} and 10^{th} carbons counting from the carbonyl carbon (C═O) and either: (i) a triple bond between the 12^{th} and 13^{th} carbons counting from the carbonyl (C═O) carbon or (ii) either a single or double bond between the 12^{th} and 13^{th} carbons and at least one substituent at one or both of the 12^{th} and 13^{th} carbons, wherein the substituents are selected from the group consisting of hydroxy, oxo, halogen, amino, cyano, azido, cyclopropane, cyclopropene, epoxy and a substituted or unsubstituted C1-C2 carbon chain. The substituents can be polar groups and/or hydrogen bond acceptors. The composition can further comprise an aqueous surfactant (or a combination of aqueous surfactants), and inhibitor of oxidation (or a combination of such inhibitors), or a permeation enhancer (or combination of permeation enhancers). The composition can also include: an aqueous surfactant and a permeation enhancer; an aqueous surfactant and an inhibitor of oxidation; or an aqueous surfactant, a permeation enhancer, and an inhibitor of oxidation.

The composition can be produced in concentrated form that includes little or no water. The composition can be diluted with water or some other solvent prior to use to treat plants, seeds, soil or vertebrates.

In various embodiments: R₁ is H or a cation; R₁ is a C1-C5 substituted or unsubstituted carbon chain, wherein the substituents are selected from the group consisting of: hydroxy, halogen, amino, cyano, cyclopropane, epoxy and a substituted or unsubstituted C1-C2 carbon chain; R₁ is a C1-C5 substituted or unsubstituted carbon chain, wherein the substituents are selected from the group consisting of: hydroxy, halogen, amino, cyano, cyclopropane, epoxy and an unsubstituted C1-C2 carbon chain; the C1-C2 carbon chain of one or both of R₁ and R₂ is substituted and the substituents are selected from the group consisting of: hydroxy, halogen, amino, cyano, and epoxy; the C1-C2 carbon chain of one or both of R₁ and R₂ is substituted and the substituents are selected from the group consisting of: hydroxy, halogen, and amino; R₁ is a substituted C1 methyl; R₁ is a C1-C2 substituted or unsubstituted carbon chain; and R₂ is a C15-C19 substituted or unsubstituted carbon chain having a cis or trans double bond between the 9^{th} and 10^{th} carbons counting from the carbonyl (C═O) carbon and either: (i) a triple bond between the 12^{th} and 13^{th} carbons counting from the carbonyl (C═O) carbon or (ii) either a single or double bond between the 12^{th} and 13^{th} carbons and at least one substituent at one or both of the 12^{th} and 13^{th} carbons, wherein the substituents are selected from the group consisting of hydroxy, oxo, halogen, amino, cyano, azido, cyclopropane, cyclopropene, epoxy and an unsubstituted C1-C2 carbon chain.

In other embodiments: the C1-C2 carbon chain of R₂ is substituted and the substituents are selected from the group consisting of: hydroxy, oxo, halogen, amino, cyano, azido, and epoxy; the C1-C2 carbon chain of R₂ is substituted and the substituents are selected from the group consisting of: hydroxy, oxo, halogen, azido, and amino; the C1-C2 carbon chain of R₂ is singly substituted; R₁ is H; R₁ is a cation (e.g., a fatty acid salt); R₂ is substituted only at one or both of 12^{th} and 13^{th} carbons counting from the carbonyl (C═O) carbon; R₂ is substituted only at the 12^{th} carbon counting from the carbonyl (C═O) carbon; R₂ is substituted only at the 13^{th} carbon counting from the carbonyl (C═O) carbon; with R₂ the substituents are polar and are selected from the group consisting of: hydroxy, oxo, epoxy, halogen, amino, cyano and azido; within R₂ the substituents are hydrogen bond acceptors and are selected from the group consisting of: hydroxy, oxo, epoxy, amino, cyano and azido; and within R₂ the substituents are selected from the group consisting of: hydroxy, oxo and epoxy.

In another embodiment, the invention features a nematicidal composition comprising: (a) a fatty acid or salt or ester or amide or aldehyde or ketone selected from the group consisting of: ricinoleic acid, ricinelaidic acid, 12-oxo-9(Z)-octadecenoic acid, 12-oxo-9(E)-octadecenoic acid, (12,13)-epoxy-trans-9-octadecenoic acid and vernolic acid; and (b) an aqueous surfactant.

In various preferred embodiments: the aqueous surfactant is selected from the group consisting of: ethyl lactate, Span 20®, Span 40®, Span 80®, Span 85®, Tween 20®, Tween 40®, Tween 80®, Tween 85®, Triton X 100®, Makon 10®, Igepal CO 630®, Brij 35®, Brij 97®, Tergitol TMN 6®, Dowfax 3B2®, Physan® and Toximul TA 15®; the composition further comprises a permeation enhancer (e.g., cyclodextrin); the composition further comprises a co-solvent (e.g., isopropanol, acetone, 1,2-propanediol, a petroleum based-oil (e.g., aromatic 200) or a mineral oil (e.g., paraffin oil)); the composition further comprises a nematicide selected from the group consisting of: avermectins (e.g., ivermectin), milbemycin, aldicarb, oxamyl, fenamiphos, fosthiazate and metam sodium; the composition further comprises an inhibitor of oxidation (e.g., butylated hydroxyanisole (BHA) and butylated hydroxytoluene (BHT)). The composition may also comprise insecticides (e.g., cinnamaldehyde, sucrose octaonate esters, spinosad), herbicides (e.g., trifloxysulfuron, glyphosate, halosulfuron) and other chemicals for disease control (e.g., chitosan).

In another embodiment, the composition comprises at least two different compounds having the formula

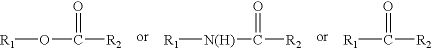

wherein:

R₁═H, a cation or a C1-C5 substituted or unsubstituted carbon chain, wherein the substituents are selected from the group consisting of: hydroxy, halogen, amino, cyano, cyclopropane, epoxy and a substituted or unsubstituted C1-C2 carbon chain; and

R₂=a C15-C19 substituted or unsubstituted carbon chain having a cis or trans double bond between the 9^{th} and 10^{th} carbons counting from the carbonyl (C═O) carbon and either: (i) a triple bond between the 12^{th} and 13^{th} carbons counting from the carbonyl (C═O) carbon or (ii) either a single or double bond between the 12^{th} and 13^{th} carbons and at least one substituent at one or both of the 12^{th} and 13^{th} carbons, wherein the substituents are selected from the group consisting of hydroxy, oxo, halogen, amino, cyano, azido, cyclopropane, cyclopropene, epoxy and a substituted or unsubstituted C1-C2 carbon chain.

In various embodiments: R₁ is H or a cation; R₁ is a C1-C5 substituted or unsubstituted carbon chain, wherein the substituents are selected from the group consisting of: hydroxy, halogen, amino, cyano, cyclopropane, epoxy and a substituted or unsubstituted C1-C2 carbon chain; R₁ is a C1-C5 substituted or unsubstituted carbon chain, wherein the substituents are selected from the group consisting of: hydroxy, halogen, amino, cyano, cyclopropane, epoxy and an unsubstituted C1-C2 carbon chain; the C1-C2-carbon chain of one or both of R₁ and R₂ is substituted and the substituents are selected from the group consisting of: hydroxy, halogen, amino, cyano, and epoxy; the C1-C2 carbon chain of one or both of R₁ and R₂ is substituted and the substituents are selected from the group consisting of: hydroxy, halogen, and amino; R₁ is a substituted C1 methyl; R₁ is a C1-C2 substituted or unsubstituted carbon chain; and R₂ is a C15-C19 substituted or unsubstituted carbon chain having a cis or trans double bond between the 9^{th} and 10^{th} carbons counting from the carbonyl (C═O) carbon and either: (i) a triple bond between the 12^{th} and 13^{th} carbons counting from the carbonyl (C═O) carbon or (ii) either a single or double bond between the 12^{th} and 13^{th} carbons and at least one substituent at one or both of the 12^{th} and 13^{th} carbons, wherein the substituents are selected from the group consisting of hydroxy, oxo, halogen, amino, cyano, azido, cyclopropane, cyclopropene, epoxy and an unsubstituted C1-C2 carbon chain.

In other embodiments: the C1-C2 carbon chain of R₂ is substituted and the substituents are selected from the group consisting of: hydroxy, oxo, halogen, amino, cyano, azido, and epoxy; the C1-C2 carbon chain of R₂ is substituted and the substituents are selected from the group consisting of: hydroxy, oxo, halogen, azido, and amino; the C1-C2 carbon chain of R₂ is singly substituted; R₁ is H; R₁ is a cation (e.g., a fatty acid salt); R₂ is substituted only at one or both of 12^{th} and 13^{th} carbons counting from the carbonyl (C═O) carbon; R₂ is substituted only at the 12^{th} carbon counting from the carbonyl (C═O) carbon; R₂ is substituted only at the 13^{th} carbon counting from the carbonyl (C═O) carbon; with R₂ the substituents are polar and are selected from the group consisting of: hydroxy, oxo, epoxy, halogen, amino, cyano and azido; within R₂ the substituents are hydrogen bond acceptors and are selected from the group consisting of: hydroxy, oxo, epoxy, amino, cyano and azido; and within R₂ the substituents are selected from the group consisting of: hydroxy, oxo and epoxy.

The invention also features compositions comprising, consisting or consisting essentially of at least one such fatty acid or fatty acid analog and an aqueous surfactant, a co-solvent or an anti-oxidant. The invention also features the use of such compositions in the control of nematodes. Also within the invention are compositions comprising, consisting or consisting essentially of at least one such fatty acid or fatty acid analog and an aqueous surfactant and an anti-oxidant. Certain compositions contain two, three, four or more different fatty acids or fatty acid analogs.

In one embodiment the fatty acids and fatty acid analogs are mixtures of compounds and in other embodiments the surfactants are mixtures of compounds. In another embodiment both the fatty acids or fatty acid analogs and surfactants are mixtures of compounds.

A permeation enhancer is generally an agent that facilitates the active compounds of the invention, e.g., the fatty acids, esters, amides, aldehydes or ketones of the invention, to pass through cellular membranes.

A co-solvent (i.e., a latent solvent or indirect solvent) is an agent that becomes an effective solvent in the presence of an active solvent and can improve the properties of the primary (active) solvent.

The compositions can also include one more nematicides such as an avermectin (e.g., ivermectin), milbemycin, aldicarb, oxamyl, fenamiphos, fosthiazate or metam sodium. The composition may also include insecticides (e.g., cinnamaldehyde, sucrose octaonate esters, spinosad), herbicides (e.g., trifloxysulfuron, glyphosate, halosulfuron) and other chemicals for disease control (e.g., chitosan).

The invention also features a method for control of unwanted nematodes, the method comprising administering to a vertebrate, a plant, a seed or soil a composition comprising:

(a) a compound having the formula

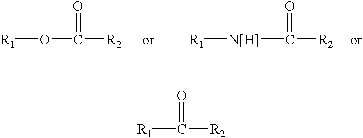

wherein:

R₁═H, a cation (e.g., a fatty acid salt) or a C1-C5 substituted or unsubstituted carbon chain, wherein the substituents are selected from the group consisting of: hydroxy, halogen, amino, cyano, cyclopropane, epoxy and a substituted or unsubstituted C1-C2 carbon chain; and

R₂=a C15-C19 substituted or unsubstituted carbon chain having a cis or trans double bond between the 9^{th} and 10^{th} carbons counting from the carbonyl (C═O) carbon and either: (i) a triple bond between the 12^{th} and 13^{th} carbons counting from the carbonyl (C═O) carbon or (ii) either a single or double bond between the 12^{th} and 13^{th} carbons and at least one substituent at one or both of the 12^{th} and 13^{th} carbons, wherein the substituents are selected from the group consisting of hydroxy, oxo, halogen, amino, cyano, azido, cyclopropane, cyclopropene, epoxy and a substituted or unsubstituted C1-C2 carbon chain.

In various embodiments: the composition further comprises an aqueous surfactant, R₁ is H or a cation; R₁ is a C1-C5 substituted or unsubstituted carbon chain, wherein the substituents are selected from the group consisting of: hydroxy, halogen, amino, cyano, cyclopropane, epoxy and a substituted or unsubstituted C1-C2 carbon chain; R₁ is a C1-C5 substituted or unsubstituted carbon chain, wherein the substituents are selected from the group consisting of: hydroxy, halogen, amino, cyano, cyclopropane, epoxy and an unsubstituted C1-C2 carbon chain; the C1-C2 carbon chain of one or both of R₁ and R₂ is substituted and the substituents are selected from the group consisting of: hydroxy, halogen, amino, cyano, and epoxy; the C1-C2 carbon chain of one or both of R₁ and R₂ is substituted and the substituents are selected from the group consisting of: hydroxy, halogen, and amino; R₁ is a substituted C1 methyl; R₁ is a C1-C2 substituted or unsubstituted carbon chain; and R₂ is a C15-C19 substituted or unsubstituted carbon chain having a cis or trans double bond between the 9^{th} and 10^{th} carbons counting from the carbonyl (C═O) carbon and either: (i) a triple bond between the 12^{th} and 13^{th} carbons counting from the carbonyl (C═O) carbon or (ii) either a single or double bond between the 12^{th} and 13^{th} carbons and at least one substituent at one or both of the 12^{th} and 13^{th} carbons, wherein the substituents are selected from the group consisting of hydroxy, oxo, halogen, amino, cyano, azido, cyclopropane, cyclopropene, epoxy and an unsubstituted C1-C2 carbon chain.

In other embodiments: the C1-C2 carbon chain of R₂ is substituted and the substituents are selected from the group consisting of: hydroxy, oxo, halogen, amino, cyano, azido, and epoxy; the C1-C2 carbon chain of R₂ is substituted and the substituents are selected from the group consisting of: hydroxy, oxo, halogen, azido, and amino; the C1-C2 carbon chain of R₂ is singly substituted; R₁ is H; R₁ is a cation; R₂ is substituted only at one or both of 12^{th} and 13^{th} carbons counting from the carbonyl (C═O) carbon; R₂ is substituted only at the 12^{th} carbon counting from the carbonyl (C═O) carbon; R₂ is substituted only at the 13^{th} carbon counting from the carbonyl (C═O) carbon; with R₂ the substituents are polar and are selected from the group consisting of: hydroxy, oxo, epoxy, halogen, amino, cyano and azido; within R₂ the substituents are hydrogen bond acceptors and are selected from the group consisting of: hydroxy, oxo, epoxy, amino, cyano and azido; and within R₂ the substituents are selected from the group consisting of: hydroxy, oxo and epoxy.

In another embodiment, the invention features a method comprising administering to a vertebrate, a plant, a seed or soil a composition comprising (a) a fatty acid or salt or ester or amide or aldehyde or ketone selected from the group consisting of: ricinoleic acid, ricinelaidic acid, 12-oxo-9(Z)-octadecenoic acid, 12-oxo-9(E)-octadecenoic acid, (12,13)-epoxy-trans-9-octadecenoic acid and vernolic acid; and (b) an aqueous surfactant.

In various preferred embodiments: the aqueous surfactant is selected from the group consisting of: ethyl lactate, Span 20®, Span 40%, Span 80®, Span 85®, Tween 20®, Tween 40®, Tween 80®, Tween 85®, Triton X 100®, Makon 10®, Igepal CO 630®, Brij 35®, Brij 97®, Tergitol TMN 6®, Dowfax 3B2®, Physan® and Toximul TA 15®; the composition further comprises a permeation enhancer (e.g., cyclodextrin); the composition further comprises a co-solvent (e.g., isopropanol, acetone, 1,2-propanediol, a petroleum based-oil (e.g., aromatic 200) or a mineral oil (e.g., paraffin oil)); the composition further comprises a nematicide selected from the group consisting of avermectins (e.g., ivermectin), milbemycin, aldicarb, oxamyl, fenamiphos, fosthiazate and metam sodium; the composition further comprises an inhibitor of oxidation (e.g., butylated hydroxyanisole (BHA) and butylated hydroxytoluene (BHT)). The composition may also comprise insecticides (e.g., cinnamaldehyde, sucrose octaonate esters, spinosad), herbicides (e.g., trifloxysulfuron, glyphosate, halosulfuron) and other chemicals for disease control (e.g., chitosan).

In another embodiment, the method comprises administering a composition comprising at least two different compounds having the formula

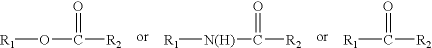

wherein:

R₁═H, a cation or a C1-C5 substituted or unsubstituted carbon chain, wherein the substituents are selected from the group consisting of: hydroxy, halogen, amino, cyano, cyclopropane, epoxy and a substituted or unsubstituted C1-C2 carbon chain; and

R₂=a C15-C19 substituted or unsubstituted carbon chain having a cis or trans double bond between the 9^{th} and 10^{th} carbons counting from the carbonyl (C═O) carbon and either: (i) a triple bond between the 12^{th} and 13^{th} carbons counting from the carbonyl (C═O) carbon or (ii) either a single or double bond between the 12^{th} and 13^{th} carbons and at least one substituent at one or both of the 12^{th} and 13^{th} carbons, wherein the substituents are selected from the group consisting of hydroxy, oxo, halogen, amino, cyano, azido, cyclopropane, cyclopropene, epoxy and a substituted or unsubstituted C1-C2 carbon chain.

In various embodiments: R₁ is H or a cation; R₁ is a C1-C5 substituted or unsubstituted carbon chain, wherein the substituents are selected from the group consisting of: hydroxy, halogen, amino, cyano, cyclopropane, epoxy and a substituted or unsubstituted C1-C2 carbon chain; R₁ is a C1-C5 substituted or unsubstituted carbon chain, wherein the substituents are selected from the group consisting of: hydroxy, halogen, amino, cyano, cyclopropane, epoxy and an unsubstituted C1-C2 carbon chain; the C1-C2 carbon chain of one or both of R₁ and R₂ is substituted and the substituents are selected from the group consisting of: hydroxy, halogen, amino, cyano, and epoxy; the C1-C2 carbon chain of one or both of R₁ and R₂ is substituted and the substituents are selected from the group consisting of: hydroxy, halogen, and amino; R₁ is a substituted C1 methyl; R₁ is a C1-C2 substituted or unsubstituted carbon chain; and R₂ is a C15-C19 substituted or unsubstituted carbon chain having a cis or trans double bond between the 9^{th} and 10^{th} carbons counting from the carbonyl (C═O) carbon and either: (i) a triple bond between the 12^{th} and 13^{th} carbons counting from the carbonyl (C═O) carbon or (ii) either a single or double bond between the 12^{th} and 13^{th} carbons and at least one substituent at one or both of the 12^{th} and 13^{th} carbons, wherein the substituents are selected from the group consisting of hydroxy, oxo, halogen, amino, cyano, azido, cyclopropane, cyclopropene, epoxy and an unsubstituted C1-C2 carbon chain.

In other embodiments: the C1-C2 carbon chain of R₂ is substituted and the substituents are selected from the group consisting of: hydroxy, oxo, halogen, amino, cyano, azido, and epoxy; the C1-C2 carbon chain of R₂ is substituted and the substituents are selected from the group consisting of: hydroxy, oxo, halogen, azido, and amino; the C1-C2 carbon chain of R₂ is singly substituted; R₁ is H; R₁ is a cation (e.g., a fatty acid salt); R₂ is substituted only at one or both of 12^{th} and 13^{th} carbons counting from the carbonyl (C═O) carbon; R₂ is substituted only at the 12^{th} carbon counting from the carbonyl (C═O) carbon; R₂ is substituted only at the 13^{th} carbon-counting from the carbonyl (C═O) carbon; with R₂ the substituents are polar and are selected from the group consisting of: hydroxy, oxo, epoxy, halogen, amino, cyano and azido; within R₂ the substituents are hydrogen bond acceptors and are selected from the group consisting of: hydroxy, oxo, epoxy, amino, cyano and azido; and within R₂ the substituents are selected from the group consisting of: hydroxy, oxo and epoxy.

In various embodiments of the method: the nematode infects plants and the composition is applied to the soil or to plants, the composition is applied to soil before planting, the composition is applied to soil after planting, the composition is applied to soil using a drip system, the composition is applied to soil using a drench system, the composition is applied to plant roots; the composition is applied to seeds; the nematode infects a vertebrate (e.g., a mammal, a bird, a non-human mammal, a human); the composition is formulated as a drench to be administered to a non-human vertebrate; and the composition is formulated as an orally administered drug; the composition is formulated as an injectable drug.

The invention also features a feed for a non-human vertebrate comprising:

(a) a feed suitable for a non-human vertebrate;

(b) a compound having the formula

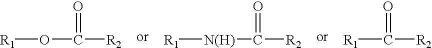

wherein:

R₁═H, a cation or a C1-C5 substituted or unsubstituted carbon chain, wherein the substituents are selected from the group consisting of: hydroxy, halogen, amino, cyano, cyclopropane, epoxy and a substituted or unsubstituted C1-C2 carbon chain; and

R₂=a C15-C19 substituted or unsubstituted carbon chain having a cis or trans double bond between the 9^{th} and 10^{th} carbons counting from the carbonyl (C═O) carbon and either: (i) a triple bond between the 12^{th} and 13^{th} carbons counting from the carbonyl (C═O) carbon or (ii) either a single or double bond between the 12^{th} and 13^{th} carbons and at least one substituent at one or both of the 12^{th} and 13^{th} carbons, wherein the substituents are selected from the group consisting of hydroxy, oxo, halogen, amino, cyano, azido, cyclopropane, cyclopropene, epoxy and a substituted or unsubstituted C1-C2 carbon chain.

In various embodiments: the feed further comprises an aqueous surfactant; the feed has been treated to reduce linoleic acid content, linolenic acid content or both; the feed has been treated to reduce both the gamma linolenic acid content and the alpha linolenic acid content; and the feed is selected from the group consisting of: soy, wheat, corn, sorghum, millet, alfalfa, clover, and rye.

The invention also features a nematicidal composition comprising:

(a) an effective amount of a compound having the formula

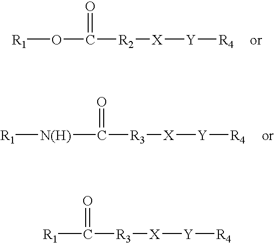

wherein:

R₁═H, a cation or a C1-C5 substituted or unsubstituted carbon chain, wherein the substituents are selected from the group consisting of: hydroxy, halogen, amino, cyano, cyclopropane, epoxy and a substituted or unsubstituted C1-C2 carbon chain;

R₃=a C11 substituted or unsubstituted carbon chain having a cis double bond between the 9 and 10^{th} carbons counting from the carbonyl (C═O) carbon, wherein the substituents are selected from the group consisting of: hydroxy, halogen, amino, cyano, cyclopropane, cyclopropene, epoxy and a substituted or unsubstituted C1-C2 carbon chain;

R₄=a C2-C6 substituted or unsubstituted carbon chain wherein the substituents are selected from the group consisting of: hydroxy, halogen, amino, cyano, cyclopropane, epoxy and a substituted or unsubstituted C1-C2 carbon chain;

X and Y are independently a substituted or unsubstituted methyl or S provided at least one or X and Y is S and wherein the substituents on the methyl selected from the group consisting of: halogen, hydrogen, amino, and hydroxy.

In various embodiment the composition further comprises an aqueous surfactant; and one of X and Y is CH₂.

The invention also features a nematicidal composition comprising;

(a) an effective amount of a compound having the formula

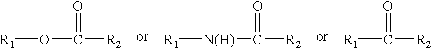

wherein:

R₁═H, a cation or a C1-C5 substituted or unsubstituted carbon chain, wherein the substituents are selected from the group consisting of: hydroxy, halogen, amino, cyano, cyclopropane, epoxy and a substituted or unsubstituted C1-C2 carbon chain; and

R₂=a C15-C19 substituted or unsubstituted carbon chain having a single bond between the 9^{th} and 10^{th} carbons counting from the carbonyl (C═O) carbon and either: (i) a triple bond between the 12^{th} and 13^{th} carbons counting from the carbonyl (C═O) carbon or (ii) either a single or double bond between the 12^{th} and 13^{th} carbons counting from the carbonyl (C═O) carbon and at least one substituent at one or both of the 12^{th} and 13^{th} carbons, wherein the substituents are selected from the group consisting of hydroxy, halogen, amino, cyano, cyclopropane, cyclopropene, epoxy and a substituted or unsubstituted C1-C2 carbon chain.

In various embodiments: the composition further comprises an aqueous surfactant; R₂ is a C15-C19 substituted or unsubstituted carbon chain having a single bond between the 9^{th} and 10^{th} carbons and a single bond between the 12^{th} and 13^{th} carbons counting from the carbonyl (C═O) carbon and at least one substituent at one or both of the 12^{th} and 13^{th} carbons counting from the carbonyl (C═O) carbon, wherein the substituents are selected from the group consisting of hydroxy, halogen, amino, cyano, cyclopropane, cyclopropene, epoxy and a substituted or unsubstituted C1-C2 carbon chain; the 12^{th} and 13^{th} carbons are substituted with an epoxy group; and 12^{th} carbon is substituted with a hydroxy group.

The invention also features compositions comprising, consisting or consisting essentially of at least one such nematicidal compound and an aqueous surfactant or a co-solvent or a permeation enhancer or an anti-oxidant and their use in control nematodes. Also within the invention are compositions comprising, consisting or consisting essentially of at least one such nematicidal compound and an aqueous surfactant and an anti-oxidant. Certain compositions contain two, three, four or more different such nematicidal compounds.

As used herein, an agent with “anthelmintic activity” is an agent, which when tested, has measurable nematode-killing activity or results in reduced fertility or sterility in the nematodes such that fewer viable or no offspring result, or compromises the ability of the nematode to infect or reproduce in its host, or interferes with the growth or development of a nematode. The agent may also display nematode repellant properties. In the assay, the agent is combined with nematodes, e.g., in a well of microtiter dish, in liquid or solid media or in the soil containing the agent. Staged adult nematodes are placed on the media. The time of survival, viability of offspring, and/or the movement of the nematodes are measured. An agent with “anthelmintic activity” can, for example, reduce the survival time of adult nematodes relative to unexposed similarly staged adults, e.g., by about 20%, 40%, 60%, 80%, or more. In the alternative, an agent with “anthelmintic activity” may also cause the nematodes to cease replicating, regenerating, and/or producing viable progeny, e.g., by about 20%, 40%, 60%, 80%, or more. The effect may be apparent immediately or in successive generations.

As used herein, the term “binding” refers to the ability of a first compound and a second compound that are not covalently linked to physically interact. The apparent dissociation constant for a binding event can be 1 mM or less, for example, 10 nM, 1 nM, and 0.1 nM or less.

As used herein, the term “binds specifically” refers to the ability of an antibody to discriminate between a target ligand and a non-target ligand such that the antibody binds to the target ligand and not to the non-target ligand when simultaneously exposed to both the given ligand and non-target ligand, and when the target ligand and the non-target ligand are both present in molar excess over the antibody.

As used herein, the term “altering an activity” refers to a change in level, either an increase or a decrease in the activity, (e.g., an increase or decrease in the ability of the polypeptide to bind or regulate other polypeptides or molecules) particularly a fatty acid desaturase-like or fatty acid desaturase activity (e.g., the ability to introduce a double bond at the delta-12 position of a fatty acid). The change can be detected in a qualitative or quantitative observation. If a quantitative observation is made, and if a comprehensive analysis is performed over a plurality of observations, one skilled in the art can apply routine statistical analysis to identify modulations where a level is changed and where the statistical parameter, the p value, is, for example, less than 0.05.

Unless otherwise specified, a “substituted” carbon, carbon chain, or methyl, alkyl can have one or more hydrogens replaced by another group, e.g., a halogen or a hydroxyl group. Thus, a carbon or carbon chain can be singly or multiply substituted.

The term “carbon chain” refers to a branched or unbranched (straight) chain

In part, the nematicidal fatty acids and fatty acid analogs described herein provide an effective, environmentally safe means of inhibiting nematode metabolism, growth, viability, fecundity, development, infectivity and/or the nematode life-cycle. The compounds may be used alone or in combination with other nematicidal agents. The greater activity reduced phytotoxicity at active concentrations (i.e., greater therapeutic window) of many of the compounds of the invention compared to prior art non-specific nematicidal fatty acid compounds allows for application post-planting and reduced handling costs providing economic incentives in addition to the environmental benefits.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 is a photograph of C. elegans grown on oleic acid methyl ester.

FIG. 2 is a photograph of C. elegans grown on linoleic acid methyl ester.

FIG. 3 is a photograph of C. elegans grown on ricinoleic acid methyl ester.

FIG. 4 is a photograph of C. elegans grown on vernolic acid methyl ester.

FIG. 5 is a set of drawings depicting the structures of ricinoleic acid, ricinelaidic acid, 12-oxo-9(Z)-octadecenoic acid, 12-oxo-9(E)-octadecenoic acid, (12,13)-epoxy-trans-9-octadecenoic acid and vernolic acid. The numbering of the carbons is indicated with the carbonyl (C═O) carbon being carbon 1.

FIG. 6 shows soil drench phytotoxicity experiments at 500 parts per million (ppm) and 100 ppm for ricinoleic acid (Ra), ricinelaidic acid (Rea) and perlargonic acid methyl ester (P).

FIG. 7 shows a test of several formulations of methyl ricinelaidate for a root knot nematode (Meloidogyne incognita) test on tomato plants grown in pots. Solutions containing active methyl ricinelaidate at 100 parts per million (ppm): MO/S85—mineral oil and Span 85®; PG/T40—propylene glycol (1,2-propanediol) and Tween 40®; T20 5:1—Tween 20®. Control tests: fenam 20—Fenamiphos® (Nemacur) at 20 ppm; T20 5:1 blnk—Tween 20® formulation blank without methylricinelaidate active); 1NT—non-treated control.

FIG. 8 shows a test of several formulations of a mixture of 77:23 ratio of methyl ricinelaidate (RE) and methyl ricinoleate (R) and several surfactants or surfactant combinations against root knot nematode (Meloidogyne incognita) infecting tomato plants in a greenhouse pot assay. Emulsifiable concentrate solutions contain the stated percentages of surfactants by weight, the remainder being the active RE/R ingredients. Surfactants are Tween 85®/Span 85®, Triton X100®/Span 85®, Brij 35®, Tergitol TMN6®, Tergitol 15S9®, Dowfax AG®, Dowfax 3B2®, Triton X100®, Brij 97®, Benzalkonium chloride and Triton X100®/isopropyl alcohol. Active ingredients are added to the soil to mimic field rates of 50 kilograms per hectare.

FIG. 9 shows a test of several formulations of a mixture of 77:23 ratio of methyl ricinelaidate (RE) and methyl ricinoleate (R) and several surfactants or surfactant combinations against root knot nematode (Meloidogyne incognita) infecting tomato plants in a greenhouse pot assay. Emulsifiable concentrate solutions contain the stated percentages of surfactants by weight, the remainder being the active RE/R ingredients. Surfactants are Tween 85®/Span 85®, Triton X100®, Triton X100®/Dowfax AG®, Triton X100®/Benzalkonium chloride, Dowfax AG®, Benzalkonium chloride. Active ingredients are added to the soil to mimic two field rates of 100 pounds per acre and 25 pounds per acre (lbsai/a approximately equals kgai/ha).

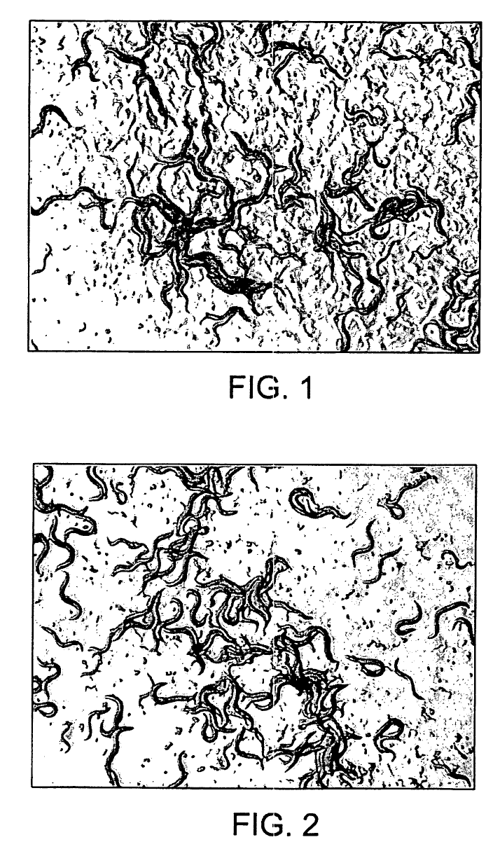

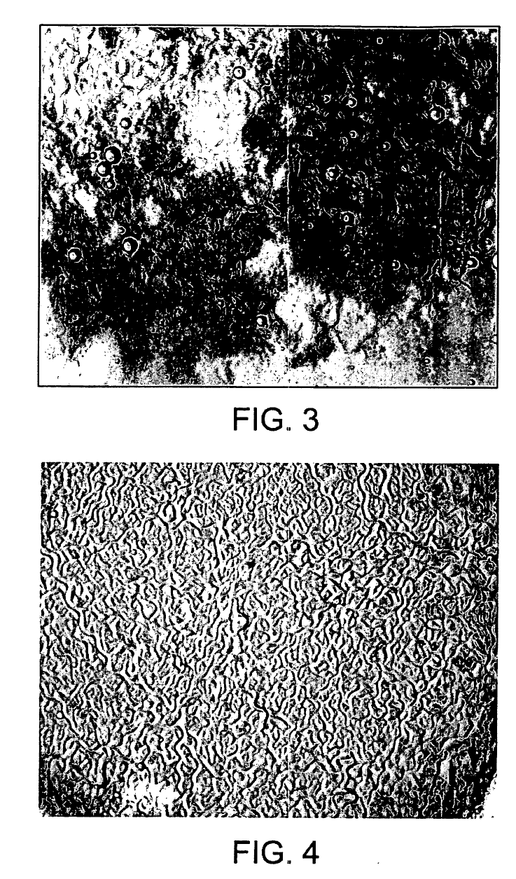

### DETAILED DESCRIPTION

Described below are experiments demonstrating that delta-12 fatty acid desaturase activity is essential for nematode viability. Also described below are certain nematicidal fatty acids and analogs, including nematicidal fatty acids and esters that have activity consistent with that of an inhibitor of a delta-12 fatty acid desaturase.

Unsaturated fatty acids are essential to the proper functioning of biological membranes. At physiological temperatures, polar glycerolipids that contain only saturated fatty acids cannot form the liquid-crystalline bilayer that is the fundamental structure of biological membranes. The introduction of an appropriate number of double bonds (a process referred to as desaturation) into the fatty acids of membrane glycerolipids decreases the temperature of transition from the gel to the liquid-crystalline phase and provides membranes with necessary fluidity. Membrane fluidity is important for maintaining the barrier properties of the lipid bilayer and for the activation and function of certain membrane bound enzymes. There is also evidence that unsaturation confers some protection to ethanol and oxidative stress, suggesting that the degree of unsaturation of membrane fatty acids has importance beyond temperature adaptation. Unsaturated fatty acids are also precursors of polyunsaturated acids (PUFAs) arachidonic and eicosapentaenoic acids in animals, which are important sources of prostaglandins. These molecules are local hormones that alter the activities of the cells in which they are synthesized and in adjoining cells, mediating processes in reproduction, immunity, neurophysiology, thermobiology, and ion and fluid transport.

The ability of cells to modulate the degree of unsaturation in their membranes is primarily determined by the action of fatty acid desaturases. Desaturase enzymes introduce unsaturated bonds at specific positions in their fatty acyl chain substrates, using molecular oxygen and reducing equivalents from NADH (or NADPH) to catalyze the insertion of double bonds. In many systems, the reaction uses a short electron transport chain consisting of NAD(P)H, cytochrome b5 reductase, and cytochrome b5, to shuttle electrons from NAD(P)H and the carbon-carbon single bond to oxygen, forming water and a double bond (C═C). Many eukaryotic desaturases are endoplasmic reticulum (ER) bound non-heme diiron-oxo proteins which contain three conserved histidine-rich motifs and two long stretches of hydrophobic residues. These hydrophobic alpha helical domains are thought to position the protein with its bulk exposed to the cytosolic face of the ER and to organize the active site histidines to appropriately coordinate the active diiron-oxo moiety.

While most eukaryotic organisms, including mammals, can introduce a double bond into an 18-carbon fatty acid at the Δ9 position, mammals are incapable of inserting double bonds at the Δ12 or Δ15 positions. For this reason, linoleate (18:2 Δ9,12) and linolenate (18:3 Δ9,12,15) must be obtained from the diet and, thus, are termed essential fatty acids. These dietary fatty acids come predominately from plant sources, since flowering plants readily desaturate the Δ12 and the Δ15 positions. Certain invertebrate animals, including some insects and nematodes, can synthesize de novo all their component fatty acids including linoleate and linolenate. The nematode C. elegans, for example, can synthesize de novo a broad range of polyunsaturated fatty acids including arachidonic acid and eicosapentaenoic acids, a feature not shared by either mammals or flowering plants (Spychalla et al. (1997) Proc. Nail. Acad. Sci. USA 94(4): 1142-7).

The C. elegans desaturase gene fat-2 has been expressed in S. cerevisiae and shown to be a delta-12 fatty acid desaturase (Peyou-Ndi et al. (2000)Arch. Biochem. Biophys. 376(2):399-408). This enzyme introduces a double bond between the 12th and the 13th carbons (from the carboxylate end) and can convert the mono-unsaturated oleate (18:1 Δ9) and palmitoleate (16:1 Δ9) to the di-unsaturated linoleate (18:2 Δ9,12) and 16:2 Δ9,12 fatty acids, respectively.

The nematode delta-12 enzymes are potentially good targets for anti-nematode compounds for several reasons. Firstly, as mentioned above, mammals are thought not to have delta-12 fatty acid desaturases. Thus, inhibitors of the enzyme are likely to be non-toxic to mammals. In addition, the enzymes appear to be phylogenetically diverged from their homologs in plants, having less than 40% pairwise sequence identity at the amino acid level and phylogenetic analyses demonstrate clustering of nematode delta-12 and ω-3 desaturases away from homologs in plants. Experiments with both transgenic Arabidopsis and soybeans reveal that plants can tolerate significant reductions in linoleate or linolenate, suggesting that inhibitors of delta-12 desaturases would likely not be toxic to plants (Miquel & Browse (1992) J. Biol. Chem. 267(3): 1502-9: Singh et al. (2000) Biochem. Society Trans. 28: 940-942; Lee et al. (1998) Science 280:915-918).

Numerous analogs of fatty acids exist and some may act as specific inhibitors of enzymes such as desaturases that act on fatty acids or as specific receptor antagonists (Yagaloff (1995) Prostaglandins Leukot Essent Fatty Acids 52(5):293-7). Sterculic acid, a cyclopropenoid fatty acid analog of oleic acid, is a potent inhibitor of delta-9 fatty acid desaturases (Schmid & Patterson (1998) Lipids 23(3):248-52; Waltermann & Steinbuchel (2000) FEMS Microbiol Lett.190(1):45-50). It has also been speculated that cyclopropenoid analogs of linoleic acid may similarly inhibit delta-12 fatty acid desaturases (Dulayymi et al. (1997) Tetrahedron 53(3):1099-1110). It is worth noting however that malvalate, a delta-8 cyclopropene fatty acid, seems to be equally inhibitory to delta-9 desaturases in some systems, as the delta-9 cyclopropene fatty acid sterculate (Schmid & Patterson (1998) Lipids 23(3):248-52), demonstrating how difficult it is to predict inhibitory profiles for some fatty acid analogs. Thia fatty acid analogs are also potential inhibitors of fatty acid desaturases (Skrede et al. (1997) Biochim Biophys Acta 1344(2):115-131; Hovik et al. (1997) Biochim Biophys Acta 1349(3):251-256) as are trans fatty acids (Choi et al. (2001) Biochem Biophys Res Commum 284(3):689-93). However, the specificity and pesticidal activity of these analogs is again difficult to predict (Beach et al. (1989) Mol Biochem Parasitol 35(1):57-66).

Certain analogs of linoleic acid that may be specific delta-12 inhibitors include the epoxy fatty acid (vernolic acid), the acetylenic fatty acid (crepenynic acid), 12-oxo-9(Z)-octadecenoic acid or the hydroxy fatty acids (ricinoleic and ricinelaidic acid). Although, naturally found in certain seed oils and previously expressed in non-native plants (e.g., Arabidopsis thaliana), fatty acid analogs such as crepenynate, ricinoleate and vernolate acids were not thought to be specific inhibitors of the endogenous delta-12 desaturase (Broun & Somerville (1997) Plant. Physiol. 113:933-942; Singh et al. (2000) Biochem. Society Trans. 28(6): 940-942). Changes in the ratio of oleate to linoleate in plants expressing the genes for these analogs was instead attributed to a negative interaction between the enzymes involved (Singh et al. (2001) Planta 212: 872-879). Addition of ricinoleate exogenously to Neurospora crassa results in a significant decrease in oleate (C18:1) and an increase in linolenate (C18:3) again providing no indication that compounds like ricinoleate were in fact specific delta-12 desaturase inhibitors (Goodrich-Tanrikulu et al. (1996) Appl Microbiol Biotechnol. 46(4):382-7).

We made the surprising discovery that the parent fatty acids, methyl esters and methyl amides of certain fatty acid analogs (e.g., ricinoleate, vernolate) are nematicidal and have activity consistent with that of specific inhibitors of nematode delta-12 desaturases. The fatty acids and methyl esters show significantly enhanced activity over other eighteen carbon free fatty acids and esters such as oleate, elaidate and linoleate. In contrast to short chain seemingly non-specific pesticidal fatty acids and esters such as pelargonate (pelargonic acid or methyl pelargonate), fatty acid analogs that are predicted delta-12 desaturase inhibitors show dramatically reduced phytoxicity and can therefore be used effectively while minimizing undesirable damage to non-target organisms.

Fatty acid analogs or other types of inhibitors may be supplied to plants exogenously, through sprays for example. The fatty acid analogs may also be applied as a seed coat or in granular form. It is also possible to provide inhibitors through a host organism or an organism on which the nematode feeds. The host organism or organism on which the nematode feeds may or may not be engineered to produce lower amounts of linoleate. For example, a host cell that does not naturally produce an inhibitor of a nematode fatty acid desaturase-like polypeptide can be transformed with genes encoding enzymes capable of making inhibitory analogs and provided with appropriate precursor chemicals exogenously if necessary. Alternatively, the active inhibitors and precursors can be made endogenously by the expression of the appropriate enzymes. In addition, yeast or other organisms can be modified to produce inhibitors. Nematodes that feed on such organisms would then be exposed to the inhibitors.

In one embodiment, transgenic cells and/or organisms could be generated that produce enzymes active on fatty acids (e.g., desaturating, hydroxylating, and/or epoxygenating enzymes). Such enzymes may be expressed, for example, in plants, vertebrates, and/or nematodes. These enzymes may produce fatty acids, analogs, or other inhibitors that can then act as specific inhibitors for other enzymes such as a fatty acid desaturase (e.g., a delta-12 epoxygenase from Crepis palaestiia produces vernolic acid in transgenic Arabidopsis) (Singh et. al. (2000) Biochem. Society Trans. 28:940-942; Lee et al. (1998) Science 280:915-918).

The fatty acid analogs used in the invention can be applied to animals, plants or the environment of plants needing nematode control or to the food of animals needing nematode control. The compositions may be applied by, for example drench or drip techniques. With drip applications fatty acid analogs can be applied directly to the base of the plants or the soil immediately adjacent to the plants. The composition may be applied through existing drip irrigation systems. This procedure is particularly applicable for cotton, strawberries, tomatoes, potatoes, vegetables and ornamental plants. Alternatively, a drench application can be used where a sufficient quantity of nematicidal composition is applied such that it drains to the root area of the plants. The drench technique can be used for a variety of crops and turf grasses. The drench technique can also be used for animals. Preferably, the nematicidal compositions would be administered orally to promote activity against internal parasitic nematodes. Nematicidal compositions may also be administered in some cases by injection of the host animal.

In a preferred embodiment of the subject invention, a compound of the invention will be applied as an aqueous micro-emulsion, emulsion or an emulsified concentrate. The concentration of the nematicidal composition should be sufficient to control the nematode without causing phytotoxicity to the desired plant or undue toxicity to the animal host.

Examples of surfactants which may be used in forming micro-emulsions, emulsions or emulsified concentrates include: Sorbitan Esters—Sorbitan Monolaurate, Sorbitan Monopalmitate, Sorbitan Monostearate, Sorbitan Tristearate, Sorbitan Monotallate, Sorbitan Monooleate, Sorbitan Sesquioleate, Sorbitan Trioleate: Ethoxylated Sorbitan Esters—polyoxyethylene (POE) (20) Sorbitan Monolaurate, POE(5) Sorbitan Monolaurate, POE(20) Sorbitan Monostearate, POE(5) Sorbitan Monostearate, POE(20) Sorbitan Tristearate. POE(20) Sorbitan Monooleate, POE(20) Sorbitan Trioleate; Ethoxylated Fatty Acids—POE(5) Oleic Acid, POE(7) Oleic Acid, POE(9) Oleic Acid, POE(5) Coconut Fatty Acid, POE(9) Coconut Fatty Acid, POE(12) Coconut Fatty Acid, POE(14) Coconut Fatty Acid, POE(8) Stearic Acid, POE(9) Stearic Acid, POE(23) Stearic Acid, POE(40) Stearic Acid, POE(100) Stearic Acid, POE(9) Pelargonic Acid, POE(9) Tall Oil Fatty Acid, POE(13) Tall Oil Fatty Acid, POE(14) Tall Oil Fatty Acid, POE(16) Tall Oil Fatty Acid, POE(9) Capric/Caprylic Acid; Polyethylenenglycol ethers—polyethylene glycol (PEG) trimethylnonyl ether, Alkyloxypolyethyleneoxyethanol; Ethoxylated fatty ethers—POE(4) laural ether, POE(23) laurel ether, POE(2) cetyl ether, POE(10) cetyl ether, POE(20) cetyl ether, POE(2) stearyl ether, POE(10) stearyl ether, POE(20) stearyl ether, POE(2) oleyl ether, POE(10) oleyl ether, POE(20) oleyl ether; PEG Fatty Acid Esters—PEG 200 Dicocoate, PEG 300 Dicocoate, PEG 400 Dicocoate, PEG 600 Dicocoate, PEG 300 Distearate, PEG 400 Distearate, PEG 600 Distearate, PEG 6000 Distearate, PEG 400 Sesquioleate, PEG 400 Dioleate, PEG 600 Dioleate, L-61 Polyalkoxylene Dioleate, PEG 400 Ditallate, PEG 600 Ditallate, Methoxy(9) Pelargonate, Methoxy(9) Laurate, Methoxy(9) Oleate; Alcohol/Fatty, Acid Esters-2-Ethylhexyl Palmitate, 2-Ethylhexyl Stearate, Isobutyl Oleate, Isohexadecy Stearate, n-Butyl Stearate, Di-Tridecyl Adipate, Tridecyl Stearate, Alkoxylated Castor Oils. POE(5) Castor Oil, POE(16) Castor Oil, POE(200) Castor Oil, POE(25) Castor Oil, POE(30) Castor Oil, POE(36) Castor Oil, POE(40) Castor Oil, POE(200) Castor Oil—50%, POE(25) Hydrogenated Castor Oil, POE(40) Hydrogenated Castor Oil, POE(60) Hydrogenated Castor Oil, POE(65) Hydrogenated Castor Oil, POE(200) Hydrogenated Castor Oil; Glycerine Esters—Glycerol Monostearate; Glycerol Monooleate (83%); Glycerol Monooleate (90%), Glycerol Tri Caprylate/Caprate; Linear Alcohol Ethoxylates—POE(6.5) Linear C12/C13 Alcohol, POE(7) Linear C12/C13 Alcohol, POE(9) Linear C12/C13 Alcohol, POE(7) Linear C12/C15 Alcohol, POE(9) Linear C12/C15 Alcohol, POE(12) Linear C12/C15 Alcohol, POE(7) Linear C14/C15 Alcohol, POE(13) Linear C14/C15 Alcohol, POE(50) Linear C16/C18 Alcohol; Ethoxylated Glycerine Esters—POE(20) Glycerol Monostearate, POE(20) Glycerol Monooleate; Ethoxylated Fatty Amines—POE(15) Cocorylamine, POE(25) Cocorylamine, POE(80) Oleylamine 80%, POE(50) Stearylamine, POE(2) Tallowamine, POE(15) Tallowamine, POE(20) Tallowamine, POE(25) Tallowamine, POE(40) Tallowamine; Block EO/PO's—F-86 Type Polyalkoxylene, L-62 Type Polyalkoxylene, L-61 Type Polyalkoxylene; Ethoxylated Alcohols—POE(2) 2-Ethyl Hexyl Alcohol, POE(8) Methyl Alcohol, POE(2) Cetyl Alcohol, POE(10) Cetyl Alcohol, POE(20) Cetyl Alcohol, POE(4) Decyl Alcohol, POE(6) Decyl Alcohol, POE(6) Decyl Alcohol-Anhydrous, POE(9) Decyl Alcohol, POE(4) Lauryl Alcohol, POE(6) Lauryl Alcohol, POE(8) Lauryl Alcohol, POE(9) Lauryl Alcohol, POE(10) Lauryl Alcohol, POE(23) Lauryl Alcohol, POE(2) Oleyl Alcohol, POE(5) Oleyl Alcohol, POE(8) Oleyl Alcohol, POE(10) Oleyl Alcohol, POE(20) Oleyl Alcohol, POE(23) Oleyl Alcohol, POE(2) Stearyl Alcohol, POE(10) Stearyl Alcohol, POE(20) Stearyl Alcohol, POE(6) Tridecyl Alcohol, POE(6) Tridecyl Alcohol-Anhydrous, POE(S) Tridecyl Alcohol, POE(9) Tridecyl Alcohol, POE(15) Tridecyl Alcohol; Alkyl Phenol Ethoxylates—POE(4) Octyl Phenol, POE(6) Octyl Phenol, POE(8) Octyl Phenol, POE(10) Octyl Phenol, POE(12) Octyl Phenol, POE(14) Octyl Phenol, POE(20) Octyl Phenol, POE(30) Octyl Phenol, POE(4) Nonyl Phenol, POE(6) Nonyl Phenol, POE(S) Nonyl Phenol, POE(10) Nonyl Phenol, POE(12) Nonyl Phenol, POE(14) Nonyl Phenol, POE(20) Nonyl Phenol, POE(30) Nonyl Phenol, POE(30) Nonyl Phenol 70%, POE(40) Nonyl Phenol, POE(40) Nonyl Phenol 70%, POE(50) Nonyl Phenol, POE(50) Nonyl Phenol 50%, POE(100) Nonyl Phenol, POE(8) Dinonyl Phenol, POE(150) Dinonyl Phenol, POE(150) Dinonyl Phenol 50%; Anionic detergents—Sodium dodecylbenzenesulfonate, Sodium dodecylsulfate; n-acyl sarcosine acids—lauroyl sarcosine, oleoyl sarcosine, myristoyl sarcosine; n-acyl sarcosine salts—sodium lauroyl sarcosinate, sodium oleoyl sarcosinate, sodium myristoyl sarcosinate; Disulfonate salts—Decyl(sulfophenoxy)benzenesulfonic acid, disodium salt; Cationic surfactants—Cetylpyridinium chloride, Cetyltrimethylammonium bromide, Myristyltrimethylammonium bromide; Quaternary ammoniums—Benzalkonium chloride, Alkyldimethylbenzylammonium chloride, Alkyldimethylethylbenzylammonium chloride, Trimethyl(tetradecyl)ammonium bromide, Dimethyldioctadecylammonium bromide, Tridodecylmethylammonium chloride, Benzyldimethyldodecylammonium bromide; Tween 20 (polyethylene glycol sorbitan monolaurate or polyoxyethylenesorbitan monolaurate); and Igepal CA 630 ((octylphenoxy)polyethoxyethanol or octylphenyl-polyethylene glycol).

Examples of solvents which may be used in forming micro-emulsions, emulsions or emulsified concentrates include: acetone, acetonitrile, dimethylsulfoxide, ethyl methyl ketone, methanol, ethanol, isopropylalcohol, 1-propanol, L-butanol, 1-pentanol, 1-hexanol, 1-octanol, 1,2 propanediol, 1,2 pentanediol, 1,2 hexanediol, 1,2 octanediol, mineral oil aliphatic petroleum hydrocarbon (Exxsol D110), aromatic petroleum hydrocarbon (Aromatic 200), ethyl lactate, toluene, xylene, cetyl alcohol

An important aspect of the invention is the surprising discovery that certain fatty acid analogs (e.g., ricinoleic acid, methyl ricinoleate, methyl ricinoleamide, ricinelaidic acid, methyl ricinelaidate, methyl ricinelaidamide, methyl vernolate) that are predicted to be specific inhibitors of nematode delta-12 desaturases are nematicidal and show significantly enhanced activity over non-specific pesticidal fatty acid esters such as oleate, elaidate and linoleate. Moreover, the compounds show reduced phytotoxicity compared to non-specific short chain pesticidal fatty acid esters such as pelargonate (pelargonic acid or methyl pelargonate). Thus, the compositions of this invention show excellent nematicidal activity at concentrations that are not phytotoxic.

The nematicidal fatty acid analogs of the invention can be applied in conjunction with another nematicidal agent. The second agent may, for example, be applied simultaneously or sequentially (e.g., within one or several hours, within one or several days, within one or several weeks) Such nematicidal agents can include for example, avermectins for animal applications and aldicarb, oxamyl, fenamiphos, fosthiazate or metam sodium for plant applications. Other agents which may be used simultaneously or sequentially with the instant invention include insecticides (e.g., cinnamaldehyde, sucrose octaonate esters, spinosad), herbicides (e.g., trifloxysulfuron, glyphosate, halosulfuron) and other chemicals for disease control (e.g., chitosan). The fatty acid analog and second agent can be applied sequentially in any order and any number of times.

A nematicidal fatty acid analog may also be coupled to an agent such as glyphosate or Tween (polyoxyethylene sorbitan) to improve phloem mobility to the roots of plants.

The aforementioned nematicidal fatty acid ester compositions can be used to treat diseases or infestations caused by nematodes of the following non-limiting, exemplary genera: Anguina, Ditylenchus, Tylenchorhynchus, Pratylenchus, Radopholus, Hirschmanniella, Nacobbus, Hoplolaimus, Scutellonema, Rotylenchus, Helicotylenchus, Rotylenchulus, Belonolaimus, Heterodera, other cyst nematodes, Meloidogyne, Criconemoides, Hemicycliophora, Paratylenchus, Tylenchulus, Aphelenchoides, Bursaphelenchus, Rhadinaphelenchus, Longidorus, Xiphinema, Trichodorus, and Paratrichodorus, Dirofiliaria, Onchocerca, Brugia, Acanthocheilonema, Aelurostrongylus, Anchlostoma, Angiostrongylus, Ascaris, Bunostomum, Capillaria, Chabertia, Cooperia, Crenosonia, Dictyocaulus, Dioctophyme, Dipetalonema, Dracunculus, Enterobius, Filaroides, Haemonchus, Lagochilascaris, Loa, Manseonella, Muellerius, Necator, Nematodirus, Oesophagostomum, Ostertagia, Parafilaria, Parascaris, Physaloptera, Protostrongylus, Setaria, Spirocerca, Stephanogilaria, Strongyloides, Strongylus, Thelazia, Toxascaris, Toxocara, Trichinella, Trichostrongylus, Trichuris, Uncinaria, and Wuchereria. Particularly preferred are nematodes including Dirofilaria, Onchocerca, Brugia, Acanthocheilonema, Dipetalonema, Loa, Mansonella, Parafilaria, Setaria, Stephanofilaria, and Wucheria, Pratylenchus, Heterodera, Meloidogyne, Paratylenchus. Species that are particularly preferred are: Ancylostoma caninum, Haemonchus contortus, Trichinella spiralis, Trichurs muris, Dirofilaria immitis, Dirofilaria tenuis, Dirofilaria repens, Dirofilari ursi, Ascaris suum, Toxocara canis, Toxocara cati, Strongyloides ratti, Parastrongyloides trichosuri, Heterodera glycines, Globodera pallida, Meloidogyne javanica, Meloidogyne incognita, and Meloidogyne arenaria, Radopholus similis, Longidorus elongatus, Meloidogyne hapla, and Pratylenchus penetrans.

The following examples are, therefore, to be construed as merely illustrative, and not limitative of the remainder of the disclosure in any way whatsoever. All of the publications cited herein are hereby incorporated by reference in their entirety.

### EXAMPLE 1

### RNA Mediated Interference (RNAi)

A double stranded RNA (dsRNA) molecule can be used to inactivate a delta-12 fatty acid desaturase (delta-12 fat-2) gene in a cell by a process known as RNA mediated-interference (Fire et al. (1998) Nature 391:806-811, and Gönczy et al. (2000) Nature 408:331-336). The dsRNA molecule can have the nucleotide sequence of a delta-12 fat-2 nucleic acid (preferably exonic) or a fragment thereof. The dsRNA molecule can be delivered to nematodes via direct injection, or by soaking nematodes in aqueous solution containing concentrated dsRNA, or by raising bacteriovorous nematodes on E. coli genetically engineered to produce the dsRNA molecule.

RNAi by injection: To examine the effect of inhibiting delta-12 fat-2 activity, a dsRNA corresponding to the C. elegans delta-12 fat-2 gene was injected into the nematode, basically as described in Mello et al. (1991) EMBO J. 10:3959-3970. Briefly, a plasmid was constructed that contains a portion of the C. elegans delta-12 fat-2 sequence, specifically a fragment 651 nucleotides long, containing the entire first exon and terminating just before the conserved intron splice junction between the first exon and first intron. This construct encodes approximately the first 217 amino acids of the C. elegans delta-12 fat-2 gene. Primers were used to specifically amplify this sequence as a linear dsDNA. Single-stranded RNAs were transcribed from these fragments using T7 RNA polymerase and SP6 RNA polymerase (the RNAs correspond to the sense and antisense RNA strands). RNA was precipitated and resuspended in RNAse free water. For annealing of ssRNAs to form dsRNAs, ssRNAs were combined, heated to 95° for two minutes then allowed to cool from 70° to room temperature over 1.5-2.5 hours.

DsRNA was injected into the body cavity of 15-20 young adult C. elegans hermaphrodites. Worms were immobilized on an agarose pad and typically injected at a concentration of 1 mg/ml. Injections were performed with visual observation using a Zeiss Axiovert compound microscope equipped with 10× and 40×DIC objectives, for example. Needles for microinjection were prepared using a Narishige needle puller, stage micromanipulator (Leitz) and a N2-powered injector (Narishige) set at 10-20 p.s.i. After injection, 200 μl of recovery buffer (0.1% salmon sperm DNA, 4% glucose, 2.4 mM KCl, 66 mM NaCl, 3 mM CaCl₂, 3 mM HEPES, pH 7.2) were added to the agarose pad and the worms were allowed to recover on the agarose pad for 0.5-4 hours. After recovery, the worms were transferred to NGM agar plates seeded with a lawn of E. coli strain OP50 as a food source. The following day and for 3 successive days thereafter, 7 individual healthy injected worms were transferred to new NGM plates seeded with OP50. The number of eggs laid per worm per day and the number of those eggs that hatch and reach fertile adulthood were determined. As a control, Green Fluorescent Protein (GFP) dsRNA was produced and injected using similar methods. GFP is a commonly used reporter gene originally isolated from jellyfish and is widely used in both prokaryotic and eukaryotic systems. The GFP gene is not present in the wild-type C. elegans genome and, therefore, GFP dsRNA does not trigger an RNAi phenotype in wild-type C. elegans. The C. elegans delta-12 FAT RNAi injection phenotype presented as a strongly reduced F1 hatch-rate, with the few surviving individuals arrested in an early larval stage.

RNAi by feeding: C. elegans can be grown on lawns of E. coli genetically engineered to produce double stranded RNA (dsRNA) designed to inhibit delta-12 fat-2 expression. Briefly, E. coli were transformed with a genomic fragment of a portion of the C. elegans fat-2 gene sequence, specifically a fragment 651 nucleotides long, containing the entire first exon and terminating just before the conserved intron splice junction between the first exon and first intron. This construct encodes approximately the first 217 amino acids of the C. elegans delta-12 FAT gene. The 651 nucleotide genomic fragment was cloned into an E. coli expression vector between opposing T7 polymerase promoters. The clone was then transformed into a strain of E. coli that carries an IPTG-inducible 17 polymerase. As a control, E. coli was transformed with a gene encoding the Green Fluorescent Protein (GFP). Feeding RNAi was initiated from C. elegans eggs or from C. elegans L4s. When feeding RNAi was started from C. elegans eggs at 23° C. on NGM plates containing IPTG and E. coli expressing the C. elegans delta-12 FAT or GFP dsRNA, the C. elegans delta-12 FAT RNAi feeding phenotype presented as partially sterile F1 individuals and dead F2 embryos. When feeding RNAi was started from C. elegans L4 larvae at 23° C. on NGM plates containing IPTG and E. coli expressing the C. elegans DELTA-12 FAT or GFP dsRNA, the C. elegans RNAi feeding phenotype presented as partially sterile PO individuals (i.e., the individuals exposed initially) with developmentally arrested, sterile F1 nematodes. The sequence of the fat-2 gene is of sufficiently high complexity (i.e., unique) such that the RNAi is not likely to represent cross reactivity with other genes.

C. elegans cultures grown in the presence of E. coli expressing dsRNA and those injected with dsRNA from the delta-12 FAT gene were strongly impaired indicating that the fatty acid desaturase-like gene provides an essential function in nematodes and that dsRNA from the fatty acid desaturase-like gene is lethal when ingested by or injected into C. elegans.

### EXAMPLE 2

### Rescue of C. elegans DELTA-12 FAT RNAi Feeding Phenotype by Linoleic Acid Methyl Ester

The C. elegans delta-12 fatty acid desaturase (FAT-2 protein) converts the mono-unsaturated oleic acid to the di-unsaturated fatty acid linoleic acid. The delta-12 FAT RNAi prevents expression of the delta-12 fatty acid desaturase, which is predicted to cause a decrease in levels of linoleic acid in the nematode, leading to arrested development and death. Addition of 3 mM linoleic acid methyl ester to the NGM media used for the RNAi experiment brings about a partial rescue of the delta-12 FAT RNAi feeding phenotype. Addition of 3 mM oleic acid methyl ester does not rescue the delta-12 FAT RNAi feeding phenotype (see Table 1 below).

TABLE 1
C. elegans delta-12 fat-2 RNAi feeding phenotypes (starting with
C. elegans L4 larvae as the P0 animal)

| Fatty Acid | | | F2 |
|---|---|---|---|
| Added | P0 phenotype | F1 phenotype | phenotype |
| None | Severely reduced | Developmentally | NA |
| | egg laying (almost | arrested and sterile | |
| | sterile) | | |
| Oleic Acid | Severely reduced | Developmentally | NA |
| Methyl Ester | egg laying (almost | arrested and sterile | |
| | sterile) | | |
| Linoleic Acid | Reduced egg laying | Moderately delayed | Slightly |
| Methyl Ester | | development and | delayed |
| | | moderately reduced | development |
| | | egg laying | |

### EXAMPLE 3

### Preparation of Caenorhabditis elegans and Fatty Acids

Mixed stage Caenorhabditis elegans were washed off plates seeded with OP50 bacteria using M9 solution. 250 μL of the M9 solution, which contained about 50-100 worms, was pipetted into each well of a 24-well plate.

With the exceptions of the fatty acid salts and the free acid of ricinelaidic acid, all other fatty acid emulsions were prepared following the teachings of Kim et al (U.S. Pat. No. 5,698,592). Briefly, 1 ml 1% stock solution emulsions were prepared by mixing 10 μl of fatty acid with 20 μl of the surfactant Igepal CO 630 in a 1.5 ml eppendorf tube. After careful mixing of fatty acid and Igepal CO 630, 850 μl of ddH₂O was added and mixed by gentle pipetting until a homogeneous solution was obtained. Finally, 120 μl of pure isopropanol was added and mixed by gentle pipetting. 1% stock emulsions were also prepared for the potassium salt of ricinoleic acid, the sodium salt of ricinelaidic acid, and ricinelaidic free acid. For the potassium salt of ricinoleic acid, 0.01 grams were dissolved in 100 μl of ddH₂O, and combined with 20 μl of the surfactant Igepal CO 630 in a 1.5 ml eppendorf tube. After careful mixing of fatty acid and Igepal CO 630, 760 μl of ddH₂O was added and mixed by gentle pipetting until a homogeneous solution was obtained. Finally, 120 μl of pure isopropanol was added and mixed by gentle pipetting. For the sodium salt and free acid of ricinelaidic acid, 0.01 grams were dissolved in 100 μl of acetone, and combined with 20 μl of the surfactant Igepal CO 630 in a 1.5 ml eppendorf tube. After careful mixing of fatty acid and Igepal CO 630, 760 μl of ddH₂O was added and mixed by gentle pipetting until a homogeneous solution was obtained. Finally, 120 μl of pure isopropanol was added and mixed by gentle pipetting. These stock solutions were then used to produce various fatty acid dilution emulsions in 24-well plate assays. An “acetone control” emulsion was prepared by combining 100 μl of acetone, 20 μl of the surfactant Igepal CO 630, 760 μl of ddH₂O, and 120 μl of pure isopropanol in a 1.5 ml eppendorf tube and mixing to homogeneity.

### EXAMPLE 4

### Nematicidal Activity of Single Fatty Acid Methyl Ester Emulsions Against Caenorhabditis elegans

To each well, fatty acid emulsions or control emulsions were added and rapidly mixed by swirling. Nematode viability was scored by visual observation and motility assays at various time points 24 hours following addition of emulsions or controls. The fatty acid emulsions tested were methyl esters of nonanoic (pelargonic) acid, ricinoleic acid, vernolic acid, linoleic acid, oleic acid, and control emulsions lacking fatty acids.

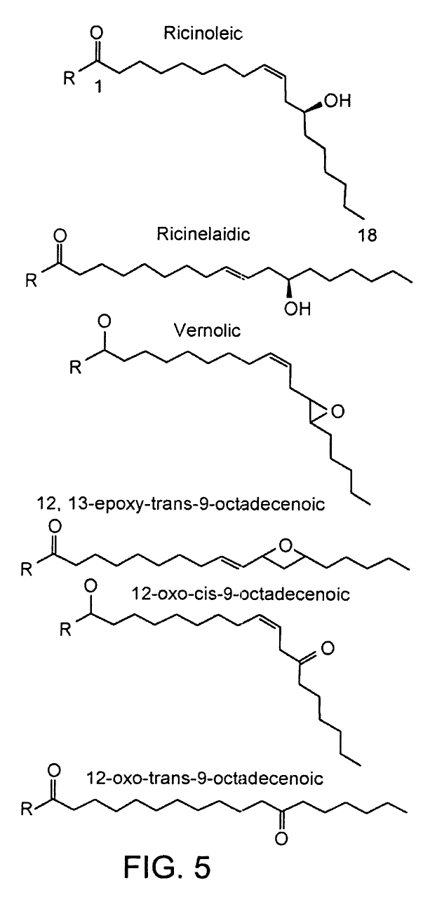

The structures of ricinoleic acid, ricinelaidic acid and vernolic acid are depicted in FIG. 5.

TABLE 2
Nematicidal activity of fatty acid methyl ester emulsions against
C. elegans

| | | Percentage of Worm Death | | |
|---|---|---|---|---|
| Fatty Acid | Concentration | 1 hr | 6 hr | 24 hr |
| Nonanoic | 0.1% | 100% | 100% | 100% |
| (C9-methyl ester) | 0.003% | 50% | 50% | 50% |
| Ricinoleic Acid | 0.1% | 90% | 90% | 90% |
| (C18-methyl ester) | 0.003% | 60% | 60% | 60% |
| Vernolic Acid | 0.1% | 65% | 65% | 75% |
| (C18-methyl ester) | 0.003% | 20% | 20% | 20% |
| Linoleic Acid | 0.1% | 0-5% | 0-5% | 0-5% |
| (C18-methyl ester) | 0.003% | 0-5% | 0-5% | 0-5% |
| Oleic Acid | 0.1% | 0-5% | 0-5% | 0-5% |
| (C18-methyl ester) | 0.003% | 0-5% | 0-5% | 0-5% |
| Control | 0.1% | 0-5% | 0-5% | 0-5% |
| (no methyl ester) | 0.003% | 0-5% | 0-5% | 0-5% |

Both nonanoic (pelargonic) and ricinoleic acid methyl ester emulsions are strongly nematicidal at a concentration of 0.1%. Nonanoic methyl ester emulsions cause an almost immediate cessation of nematode movement and subsequent death whereas ricinoleic methyl ester emulsions require up to several hours before strong killing effects are apparent. However, at 0.003%, nonanoic acid methyl ester emulsions temporarily “stunned” C. elegans, initially giving the appearance of a 100% death phenotype. Several hours post inoculation, many nematodes recover and start moving again. This “stun” effect was not observed with the other fatty acid emulsions. Oleic acid methyl ester was not nematicidal.

### EXAMPLE 5

### Nematicidal Activity of Single Fatty Acid Methyl Ester, Salt and Free Fatty Acid Emulsions Against Caenorhabditis elegans N2s and Dauers

L: linoleic acid, R: ricinoleic acid, Re: ricinelaidic; V-trans: (12,13)-epoxy-trans-9-octadecenoic

TABLE 3
Results vs. C. elegans (worm death)

| | Fatty Acid | | |
|---|---|---|---|
| | 0.1% | 0.01% | 0.001% |
| Castor Oil | 10% | <5% | NA |
| Pelargonic ME | 100% | 100% | 30% |
| L ME | <5% | <5% | <5% |
| L free acid | 10% | <5% | <5% |
| R ME | 80% | 40% | 20% |
| R free acid | 95% | 50% | <5% |
| Re ME | 100% | 100% | 80% |
| Re free acid* | 100% | 98% | 40% |
| Potassium R | 90% | 15% | 5% |
| Sodium Re* | 100% | 100% | NA |
| Acetone control | 10% | 5% | 5% |

TABLE 4
Results vs. C. elegans dauers (worm death)

| | Fatty Acid | | |
|---|---|---|---|
| | 0.1% | 0.01% | 0.001% |
| Castor Oil | NA | NA | NA |
| Pelargonic ME | NA | NA | NA |
| L ME | 40% | 20% | NA |
| L free acid | 50% | 40% | NA |
| R ME | 70% | 30% | NA |
| R free acid | 90% | 75% | NA |
| Re ME | 100% | 100% | NA |
| Re free acid* | 75% | 75% | NA |
| Potassium R | 75% | 20% | NA |
| Sodium Re* | NA | NA | NA |
| Acetone control | 35% | 20% | NA |
| V-trans ME | 90% | 50% | NA |

As can be seen from Tables 3 and 4, ricinoleic and ricinelaidic acid, salt and methyl ester and (12,13)-epoxy-trans-9-octadecenoic acid methyl ester (the trans isomer of methyl vernolate) show significant nematicidal activity against both normally fed C. elegans N2 worms and C. elegans dauer larvae. In C. elegans, the dauer pathway is an alternate life-cycle entered in response to crowding and starvation. Dauers are an environmentally resistant stage and are thought to be functionally analogous to the dispersal larval stages of certain nematode parasites (e.g., the J2 stage of Meloidogyne and Heterodera species). Castor oil (the natural triglyceride form of ricinoleic acid), linoleic acid and linoleic acid methyl ester are not strongly nematicidal in this assay.

### EXAMPLE 6

### Preparation of Root Knot Nematode J2 Larvae (Meloidogyne spp.)

Meloidogyne incognita and javanica were prepared from tomato roots. The roots were bleached and the debris was separated from the J2 larvae and eggs by filtration followed by sucrose density gradient centrifugation. Eggs were hatched over 4 days at 15° C. and the J2 larvae were collected by passage though a filter, followed by centrifugation.

### EXAMPLE 7

### Nematicidal Activity of Fatty Acid Methyl Ester Emulsions Against Root Knot Nematodes (Meloidogyne spp.)

Nematodes and emulsions were incubated with shaking at room temperature for 48 hours. The contents of each well were transferred to a small spot on individual NGM plates lacking bacteria. About 24 hours after the transfer to plates, worms on and off the inoculation spot were counted as not viable or viable, respectively. Worms were considered viable if they had crawled away from the inoculation spot, or if they were moving. Worms were considered non-viable if they remained at the inoculation spot.

TABLE 5
Nematicidal activity of fatty acid methyl ester emulsions against
M. javanica and M. incognita

| Fatty acid | M. javanica | M. incognita |
|---|---|---|
| (0.1%) | (% not viable) | (% not viable) |
| Vernolic Acid | 90% | 100% |
| (C18-methyl ester) | | |
| Nonanoic | 100% | 100% |
| (C9-methyl ester) | | |
| Ricinoleic Acid | 60% | 95% |
| (C18-methyl ester) | | |
| Oleic Acid | 20% | 25% |
| (C18-methyl ester) | | |

Nonanoic, vernolic and ricinoleic acid methyl ester emulsions have significant nematicidal activity against root knot nematodes (Meloidogyne spp.) at a concentration of 0.1%.

### EXAMPLE 8

### Phytotoxicity Evaluations of Fatty Acid Methyl Esters

Sterilized tomato seeds were germinated in magenta jars containing Gamborg's agar media. After two weeks of growth, seedlings were treated with 250 μl of 1% fatty acid methyl ester emulsion (nonanoic acid, ricinoleic acid, ricinelaidic acid, oleic acid, or a control emulsion lacking any fatty acid), applied directly to the stem-media interface. Tomato seedlings were scored at various times after application of emulsions. Of the fatty acids tested, only 1% nonanoic acid methyl ester emulsion showed obvious effects on the tomatoes. Within 18 hours of nonanoic acid emulsion application, those tomatoes showed a distinct loss of turgor pressure (wilting phenotype) and had become noticeably less green in appearance. Within 24 hours, nonanoic acid treated tomatoes were almost entirely bleached to a pale white color and had nearly totally collapsed with most leaves lying directly on the agar media surface. Importantly, none of the tomatoes treated with the other fatty acid methyl ester emulsions showed visible effects. Therefore, ricinoleic and ricinelaidic (see examples 9-12) acid methyl esters show excellent potential as anthelmintic chemicals based on their combination of high nematicidal properties and with favorable low phytotoxicity.

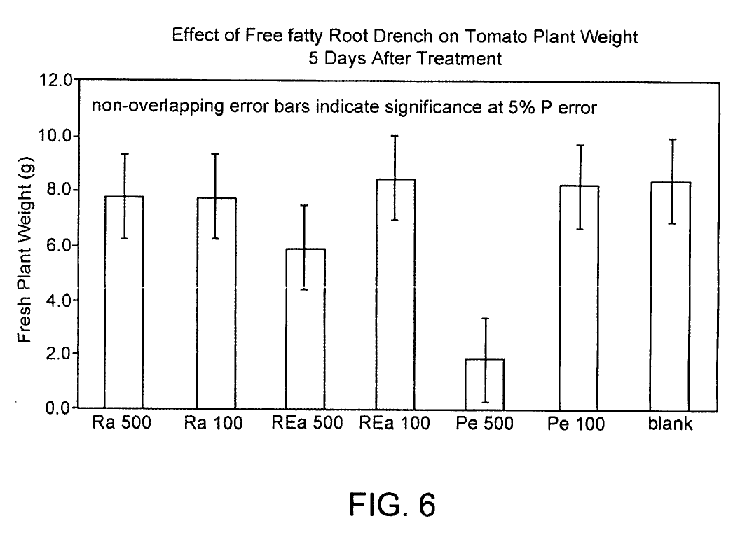

Furthermore, as can be seen in FIG. 6 even the free fatty acids of ricinoleic and ricinelaidic acid show less phytotoxicity to tomato plants in root drench soil experiments than methyl pelargonate.

### EXAMPLE 9

### Nematicidal Activity of Single Fatty Acid Methyl Ester Emulsions Against a Spectrum of Free-Living, Animal Parasitic, and Plant Parasitic Nematodes

Briefly, the indicated fatty acid emulsions were added and rapidly mixed by swirling. Nematode viability was scored by visual observation and motility assays 24 hours following addition of emulsions (48 hours for plant parasitic nematodes Meloidogyne and Heterodera species). The fatty acid emulsions tested were methyl esters of nonanoic (pelargonic) acid, ricinelaidic acid, ricinoleic acid, vernolic acid, linoleic acid, and oleic acid. Results for fatty acid emulsions against free living, animal parasitic, and plant parasitic nematodes are combined in one table to facilitate comparison of different emulsion activities against nematodes exhibiting diverse lifestyles. Results shown are mean % values obtained from multiple independent experiments

TABLE 6
Nematicidal activity of various fatty acid methyl esters against various free-
living, animal parasitic, and plant parasitic nematodes

| | % Worm Death (24 hr) | | | | | |
|---|---|---|---|---|---|---|
| | −control | | Inhibitors | | | +control |
| Worm (% solution) | Oleic | Linoleic | Vernolic | Ricinoleic | Ricinelaidic | Nonanoic |
| C. elegans (0.1%) | <10 | <10 | 80 | 100 | 100 | 100 |
| C. elegans (0.01%) | <10 | <10 | 50 | 80 | 100 | 100 |
| C. elegans (0.001%) | | <10 | 30 | 30 | 75 | 30 |
| P. trichosuri (0.1%) | ~10 | ~25 | ~95 | ~50 | 100 | |
| P. trichosuri (0.01%) | ~10 | ~25 | ~90 | ~60 | 100 | |
| P. trichosuri (0.001%) | | | | | | |
| M. incognita (0.1%) | | 20 | 98 | 95 | ~99 | 100 |
| M. incognita (0.01%) | | 20 | 73 | 83 | ~99 | |
| M. incognita (0.001%) | | | | | 97 | |
| M. javanica (0.1%) | | 20 | 90 | 60 | 100 | 100 |
| M. javanica (0.01%) | | 0-5 | 60 | 5 | 100 | |
| M. javanica (0.001%) | | | | | ~60 | |
| H. glycines (0.1%) | <10 | <20 | 30 | ~60 | 100 | 100 |
| H. glycines (0.01%) | <10 | <20 | 20 | ~60 | 100 | >95 |
| H. glycines (0.001%) | <10 | <20 | 18 | ~40 | 100 | |
| P. scribneri (0.1%) | <20 | <20 | <20 | <20 | ~70 | <20 |
| P. scribneri (0.01%) | <20 | <20 | <20 | <20 | ~40 | <20 |
| P. scribneri (0.001%) | | | | | | |

The Caenorhabiditis elegans were mixed stage populations. Similar effects seen on several other free-living nematode species. The Parastrongyloides trichosuri (parasite of Australian bushtail possum) were dauer-like infective 3^{rd} stage larva. Similar effects are also seen against free-living stages. The Meloidogyne incognita and Meloidogyne javanica (root knot nematode) were 2^{nd} stage juveniles (dauer-like infective stage). The Heterodera glycines (soybean cyst nematode) were 2^{nd} stage juveniles (dauer-like infective stage). Finally, the Pratylenchus scribneri (corn lesion nematode) were mixed stage populations.

As the data in the table above demonstrate, both ricinelaidic and ricinoleic acid methyl ester emulsions are strongly nematicidal at concentrations of 0.1% and 0.01%. Ricinelaidic acid methyl ester in particular showed favorable nematicidal activity against a wide spectrum of divergent nematode genera.

### EXAMPLE 10

### Nematicidal Activity of Single Fatty Acid Methyl Ester Emulsions Made with Tween-20 (Replacing Igepal CO 630) Against Caenorhabditis elegans

Some nematodes assayed as described in Example 9 lacked tolerance to emulsions made with the surfactant Igepal CO 630. For this reason some assays were repeated with Tween-20-based emulsions.

Briefly, 1 ml 1% stock solution emulsions were prepared by mixing 10 μl of fatty acid methyl ester with 20 μl of the surfactant Tween-20 in a 1.5 ml eppendorf tube. After careful mixing of fatty acid and Tween-20, 850 μl of ddH20 was added and mixed by gentle pipetting until a homogeneous solution was obtained. Finally, 120 μl of pure isopropanol was added and mixed by gentle pipetting. This stock solution was then used to produce various fatty acid methyl ester dilution emulsions in 24-well plate assays.

TABLE 7
Nematicidal activity of various fatty acid methyl esters emulsions with
Tween-20 against C. elegans

| | % Worm Death (24 hr) | | | | | |
|---|---|---|---|---|---|---|
| | −control | | inhibitors | | | +control |
| Worm (% solution) | Oleic | Linoleic | Vernolic | Ricinoleic | Ricinelaidic | Pelargonic |
| C. elegans (0.1%) | | <10 | | 100 | 100 | 100 |
| C. elegans (0.01%) | | <10 | | 100 | 100 | 100 |
| C. elegans (0.001%) | | | | 40 | 60 | 30 |

As shown in the Table above, fatty acid methyl ester emulsions made with Tween-20 replacing Igepal CO 630 exhibited comparable nematicidal activity to Igepal-based emulsions.

### EXAMPLE 11

### Nematicidal Activity of Single Fatty Acid Methyl Ester Emulsions Made with Cyclodextrins (Replacing Isopropanol) Against Caenorhabditis elegans

In an effort to increase the bioavailability of fatty acid methyl esters in emulsions, isopropanol was replaced with one of two cyclodextrins (Methyl-β-Cyclodextrin or 2-Hydroxypropyl-β-Cyclodextrin).

TABLE 8
Nematicidal activity of various fatty acid methyl ester emulsions with
cyclodextrins against C. elegans

| | % Worm Death (24 hr) | | | | | |
|---|---|---|---|---|---|---|
| | −control | | inhibitors | | | +control |
| Worm (% solution) | Oleic | Linoleic | Vernolic | Ricinoleic | Ricinelaidic | Pelargonic |
| C. elegans (0.1%) | | <10 | | >95 | | |
| C. elegans (0.01%) | | <10 | | >80 | | |
| C. elegans (0.001%) | | | | ~50 | | |

Results for the most effective cyclodextrin emulsion formulation (10 μl fatty acid, 20 μl igepal CO 630, 60 μl 2-Hydroxypropyl-β-Cyclodextrin, and 910 μl of H₂O) are shown above.

### EXAMPLE 12

### Nematicidal Activity of Fatty Acid Methyl Ester Emulsions Against Animal Parasitic Microfilarial Nematodes (Brugia malayi)

To each well, Tween-based fatty acid emulsions were added and rapidly mixed by swirling. Nematode microfilaria viability was scored by visual observation of motility at 24 and 48 hours following addition of emulsions. The fatty acid emulsions tested were methyl esters of ricinoleic acid, vernolic acid, ricinelaidic acid, oleic acid, and control emulsions lacking fatty acids. The results of this study are presented in Table 9 as the percentage of non-motile microfilaria 24 hours after inoculation and in Table 10 as the percentage of non-motile microfilaria 48 hours after inoculation.

TABLE 9
Nematicidal activity of fatty acid methyl ester emulsions against
B. malayi 24 hrs post-inoculation

| Inhibitor | 0.0% | 0.0008% | 0.0016% | 0.003% | 0.005% | 0.0067% | 0.008% |
|---|---|---|---|---|---|---|---|
| Ricinoleic | 0 | 0 | 24.7 | 100 | 100 | 100 | 100 |
| Vernolic | 0 | 0 | 0 | 0 | 66 | 100 | 100 |
| Ricinelaidic | 0 | 0 | 19.1 | 100 | 100 | 100 | 100 |
| Oleic | 0 | 0 | 0 | 0 | 0 | 0 | 0 |
| Blank | 0 | 0 | 0 | 0 | 0 | 0 | 0 |

TABLE 10
Nematicidal activity of fatty acid methyl ester emulsions against
B. malayi 48 hrs post-inoculation

| Inhibitor | 0.0% | 0.0008% | 0.0016% | 0.003% | 0.005% | 0.0067% | 0.008% |
|---|---|---|---|---|---|---|---|
| Ricinoleic | 0 | 0 | 64.2 | 100 | 100 | 100 | 100 |
| Vernolic | 0 | 0 | 0 | 5 | 100 | 100 | 100 |
| Ricinelaidic | 0 | 0 | 49.4 | 100 | 100 | 100 | 100 |
| Oleic | 0 | 0 | 0 | 0 | 0 | 0 | 0 |
| Blank | 0 | 0 | 0 | 0 | 0 | 0 | 0 |

As shown by the results in the Tables above, both ricinoleic and ricinelaidic methyl esters exhibited strong microfilarialcidal activity against B. malayi (somewhat stronger than the activity of vernolic acid methyl esters) in Tween-based emulsions.

### EXAMPLE 13

### Nematicidal Activity of Fatty Acid Methyl Ester Emulsion Mixtures Against C. elegans

To each well, fatty acid emulsion mixtures or control emulsions were added and rapidly mixed by swirling. Nematode viability was scored by visual observation and motility assays at various time points 24 hours following addition of emulsions or controls. The fatty acid emulsion mixtures tested were methyl esters of ricinelaidic acid, ricinoleic acid, oleic acid and control emulsions lacking fatty acids.

TABLE 11
Nematicidal activity of fatty acid methyl ester emulsion mixtures
against C. elegans 24 hrs post-inoculation

| Fatty Acid Mixture | % total fatty acids | % dead |
|---|---|---|
| 75% Ricinelaidic/ | 0.1 | 100 |
| 25% Ricinoleic | | |
| | 0.01 | 100 |
| 50% Ricinelaidic/ | 0.1 | 100 |
| 50% Ricinoleic | | |
| | 0.01 | 99 |
| 25% Ricinelaidic/ | 0.1 | 100 |
| 75% Ricinoleic | | |
| | 0.01 | 97 |
| 75% Ricinelaidic/ | 0.1 | 100 |
| 25% Oleic | | |
| | 0.01 | 100 |
| 50% Ricinelaidic/ | 0.1 | 99 |
| 50% Oleic | | |
| | 0.01 | 99 |
| 25% Ricinelaidic/ | 0.1 | 97 |
| 75% Oleic | | |
| | 0.01 | 38 |
| 75% Ricinelaidic/ | 0.075 | 100 |
| 25% Blank | | |
| | 0.0075 | 100 |
| 50% Ricinelaidic/ | 0.05 | 100 |
| 50% Blank | | |
| | 0.005 | 100 |
| 25% Ricinelaidic/ | 0.025 | 100 |
| 75% Blank | | |
| | 0.0025 | 100 |

N.B. Blank is the stock emulsion with no fatty acid added. Since there is no fatty acid in the blank, Ricinelaidic/Ricinoleic, Ricinelaidic/Oleic, and Ricinelaidic/blank mixture comparisons have equal amounts of emulsion components and equal amounts of Re when compared at the same percentages. However, the Re/blank experiment has less total fatty acid so the 0.1 and 0.01% assays have to be multiplied by the % Re to get the total fatty acid added.

### EXAMPLE 14

### Nematicidal Activity of Fatty Acid Emulsion Mixtures Against C. Elegans

To each well, fatty acid emulsion mixtures or control emulsions were added and rapidly mixed by swirling. Nematode viability was scored by visual observation and motility assays at various time points 24 hours following addition of emulsions or controls. The fatty acid emulsion mixtures tested were ricinelaidic acid, ricinoleic acid, oleic acid and control emulsions lacking fatty acids.

TABLE 12
Nematicidal activity of fatty acids emulsion mixtures against C. elegans
24 hrs post-inoculation

| Fatty Acid Mixture | % total fatty acids | % dead |
|---|---|---|
| 100% Ricinelaidic | 0.1 | 100 |
| | 0.01 | 100 |
| 100% Ricinoleic | 0.1 | 99 |
| | 0.01 | <10 |
| 100% Oleic | 0.1 | <10 |
| | 0.01 | <10 |
| 75% Ricinelaidic/ | 0.1 | 100 |
| 25% Ricinoleic | | |
| | 0.01 | 100 |
| 50% Ricinelaidic/ | 0.1 | 100 |
| 50% Ricinoleic | | |
| | 0.01 | 100 |
| 25% Ricinelaidic/ | 0.1 | 100 |
| 75% Ricinoleic | | |
| | 0.01 | 96.5 |
| 75% Ricinelaidic/ | 0.1 | 100 |
| 25% Oleic | | |
| | 0.01 | 100 |
| 50% Ricinelaidic/ | 0.1 | 100 |
| 50% Oleic | | |
| | 0.01 | 100 |
| 25% Ricinelaidic/ | 0.1 | 100 |
| 75% Oleic | | |
| | 0.01 | 89 |

### EXAMPLE 15

### Nematicidal Activity of various Ricinelaidic Acid Methyl Ester Formulations Against Meloidogyne incognita (Root Knot Nematode) in Tomato Pot Tests

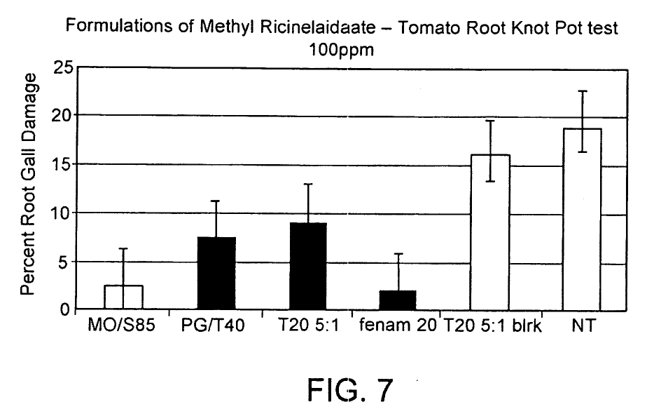

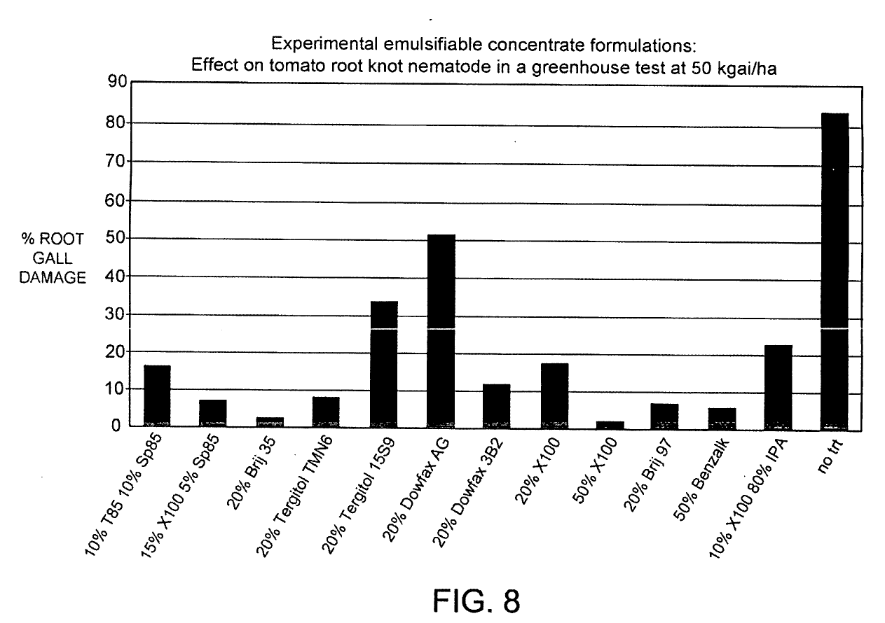

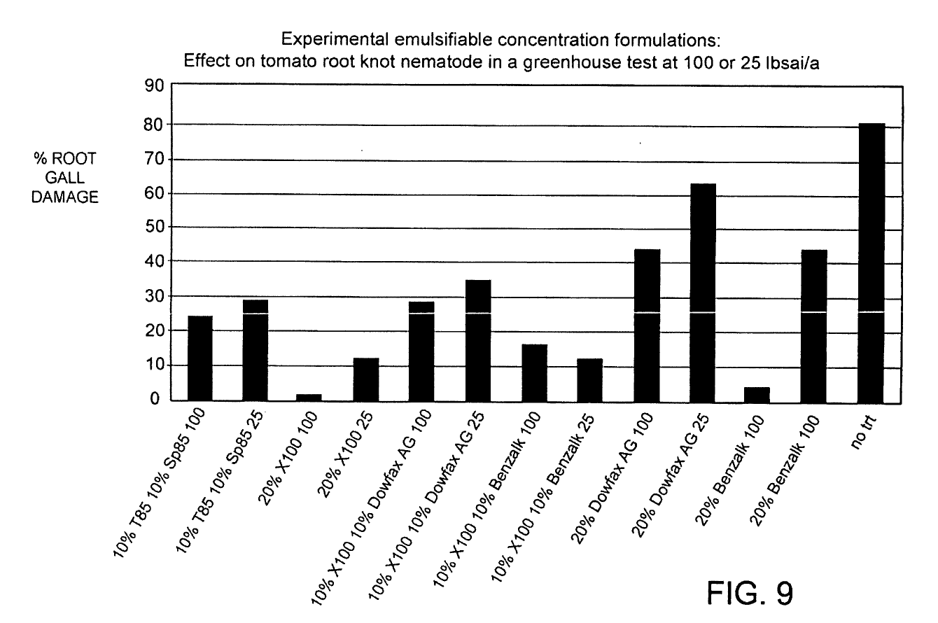

Three-week old tomato plants grown in 3 inch pots containing loamy sand (FIG. 7) or pure sand (FIGS. 8 and 9) were drenched with compound one day before inoculation (FIG. 7) or four to six hours before inoculation (FIGS. 8 and 9). Compound was applied at 100 or 500 ppm based on soil weight at field moisture capacity (FIG. 7). Roughly 50, 20 and 10 mg are added to 290 grams of sand to give 100, 50 and 25 kgai/hectare (or lbsai/acre) respectively (FIGS. 8 and 9). The studies of FIG. 7 employed methyl ricinelaidate at 100 parts per million. The studies of FIGS. 8 and 9 employed a mixture of 77:23 ratio of methyl ricinelaidate (RE) and methyl ricinoleate (R). The soil was then inoculated with 5000 J2 larvae of Meloidogyne incognita. Root gall rating and top/root fresh weights were determined 3 weeks after inoculation.

As is shown in FIGS. 7, 8 and 9 the choice of surfactant and co-solvent can significantly impact the potency of ricinelaidic acid methyl ester formulation against root knot nematode in soil assays. Comparison with a currently used environmentally toxic nematicide fenamiphos shows that the level of nematode control with methyl ricinelaidate in soil assays is significant.

### EXAMPLE 16

TABLE 13
Examplery emulsifiable concentrates

| | | | | | |
|---|---|---|---|---|---|
| EC0 | | 25% RE | 25% propylene | 50% Tween 40 | |
| | | | glycol | | |
| EC1 | | 50% RE | 35% mineral oil | 5% Tween 85 | 5% Span 85 |
| EC2 | | 75% RE | 10% acetone | 10% Tween 20 | 5% Span 85 |
| EC3 | 15% R | 35% RE | 40% mineral oil | 5% Tween 85 | |
| EC4 | 24% R | 56% RE | 10% acetone | 10% Tween 20 | |
| EC5 | 24% R | 56% RE | 10% Tween 85 | 10% Span 85 | |
| EC6 | 24% R | 56% RE | 10% Tween 20 | 10% Span 85 | |
| EC7 | | 80% RE | 10% Tween 85 | 10% Span 85 | 10% Aromatic |
| | | | | | 200 |
| EC8 | | 70% RE | 10% Span 85 | 10% Tween 85 | |
| EC9 | | 50% RE | 25% Span 85 | 25% Tween 85 | 20% mineral oil |
| EC10 | | 60% RE | 10% Span 85 | 10% Tween 85 | |
| EC11 | 10% R | 40% RE | 50% T20 | | |
| EC12 | 16% R | 64% RE | 10% T85 | 10% Aromatic | 10% Aromatic |
| | | | | 200 | 200 |
| EC13 | 16% R | 64% RE | 5% Span 85 | 5% Tween 85 | 10% mineral oil |
| EC14 | 16% R | 64% RE | 5% Span 85 | 5% Tween 85 | |
| EC15 | | 80% | 10% Tween 85 | 10% Span 85 | 10% Aromatic |
| | | POS3/10 | | | 200 |
| EC16 | | 80% | 5% Tween 85 | 5% Span 85 | |
| | | POS3/10 | | | |
| EC17 | | 50% POS3/10 | 50% Tween 20 | | 10% Exxsol |
| | | | | | D110 |
| EC18 | | 80% POS3/10 | 5% Tween 85 | 5% Span 85 | |
| EC19 | | DC7673 | 10% Tween 85 | 10% Span 85 | 10% Exxsol |
| | | | | | D110 |
| EC20 | | DC7673 | 5% Tween 85 | 5% Span 85 | |
| EC21 | | DC7679 R | 10% Tween 85 | 10% Span 85 | |
| EC22 | | DC7673 | 20% Triton X-100 | | |
| EC23 | | 80% | 10% Tween 85 | 10% Span 85 | |
| | | POS4/29/03 | | | |
| EC24 | | 80% | 15% Triton X-100 | 5% Span 85 | |
| | | POS4/29/03 | | | |
| EC25 | | 80% | 20% Brij 35 | | |
| | | POS4/29/03 | | | |
| EC26 | | 80% | 20% Tergitol | | |
| | | POS4/29/03 | TMN6 | | |
| EC27 | | 80% | 20% Tergitol | | |
| | | POS4/29/03 | 15S9 | | |
| EC28 | | 80% | 20% Dowfax AG | | |
| | | POS4/29/03 | | | |
| EC29 | | 80% | 20% Dowfax 3B2 | | |
| | | POS4/29/03 | | | |
| EC30 | | 80% | 20% Triton X100 | | |
| | | POS4/29/03 | | | |
| EC31 | | 50% | 50% Triton X100 | | |
| | | POS4/29/03 | | | |
| EC32 | | 80% | 20% Brij 97 | | |
| | | POS4/29/03 | | | |
| EC33 | | 50% | 50% benzalkonium chloride | | |
| | | POS4/29/03 | | | |
| EC34 | | 10% | 10% Triton X-100 | 80% IPA | |
| | | POS4/29/03 | | | |
| EC35 | | 80% | 20% Dawn | | 5% Tween 85 |
| | | POS4/29/03 | | | |
| EC36 | | 50% | 40% MO | 5% Span 85 | |
| | | POS4/29/03 | | | |
| EC37 | | 80% | 10% Span 85 | 10% Triton X- | |
| | | POS4/29/03 | | 100 | |
| EC38 | | 80% | 20% benzalkonium chloride | | |
| | | POS4/29/03 | | | |
| EC39 | | 80% | 10% Triton X100 | 10% benzalkonium chloride | |
| | | POS4/29/03 | | | |
| EC40 | | 80% | 10% Triton X100 | 10% Dowfax AG | |
| | | POS4/29/03 | | | |
| EC41 | | 80% | 10% Triton X100 | 10% Dowfax | |
| | | POS4/29/03 | | 3B2 | |
| EC42 | | 80% | 10% Dowfax AG | 10% benzalkonium chloride | |
| | | POS4/29/03 | | | |
| EC43 | | 80% | 10% Dowfax 3B2 | 10% benzalkonium chloride | |
| | | POS4/29/03 | | | |
| EC44 | | 80% | 20% Ninex | | |
| | | POS4/29/03 | MT615 | | |
| EC45 | | 80% | 20% Toximul | | |
| | | POS4/29/03 | TA15 | | |
| EC46 | | 80% | 20% Toximul | | |
| | | POS4/29/03 | 8240 | | |
| EC47 | | 11.4% | 3.5% Pemulen in | | |
| | | POS4/29 | water | | |
| EC48 | | 80% | 10% SDS | 10% Triton | |
| | | POS4/29/03 | | X100 | |
| EC49 | | 80% | 20% Ninex | | |
| | | POS4/29/03 | MT603 | | |
| EC50 | | 80% | 20% Ninex | | |
| | | POS4/29/03 | MT630 | | |
| EC51 | | 80% | 20% Microstep | | |
| | | POS4/29/03 | H307A | | |
| EC52 | | 80% | 20% Stepfac | | |
| | | POS4/29/03 | 8180 | | |
| EC53 | | 80% | 20% Makon 4 | | |
| | | POS4/29/03 | | | |
| EC54 | | 80% | 20% Toximul | | |
| | | POS4/29/03 | 3404F | | |
| EC55 | | 80% | 20% Toximul | | |
| | | POS4/29/03 | 3473F | | |
| EC56 | | 80% | 20% Hamposyl L | | |
| | | POS4/29/03 | | | |
| EC57 | | 80% | 20% Hamposyl M | | |
| | | POS4/29/03 | | | |
| EC58 | | 80% | 20% Hamposyl O | | |
| | | POS4/29/03 | | | |
| EC59 | | 80% | 20% Makon 10 | | |
| | | POS4/29/03 | | | |
| EC60 | | 80% | 20% Triton X45 | | |
| | | POS4/29/03 | | | |
| EC61 | | 70% | 20% Brij 97 | 10% n-butanol | |
| | | POS4/29/03 | | | |
| EC62 | | 90% | 10% Triton X100 | | |
| | | POS4/29/03 | | | |
| EC63 | | 80% | 10% Triton X100 | 10% Physan | |
| | | POS4/29/03 | | | |
| EC64 | | 80% | 20% Makon 30 | | |
| | | POS4/29/03 | | | |
| EC65 | | 80% | 10% Makon 4 | 10% Makon 30 | |
| | | POS4/29/03 | | | |
| EC66 | | 80% | 10% Makon 10 | 10% Makon 30 | |
| | | POS4/29/03 | | | |

Table 16 provides examples (EC0-EC66) of various emulsifiable concentrates with a variety of surfactants and solvents and ricinelaidic acid methyl ester (RE) and ricinoleic acid methyl ester (R). Percentages are by weight of the total mixture. For EC0-EC16 The percent weight RE and or R is shown as well as the percent weight of surfactant and/solvent. For EC17-EC66 the weight percent of one of two different fatty acid ester mixtures (POS3/10=62:38 ratio of RE:R and 90.4% hydroxyl fatty acid methyl esters (RE plus R) with the remainder being other fatty acid methyl esters like methyl oleate and methyl linoleate; POS4/29/03=77:23 ratio of RE:R and 91% hydroxyl fatty acids (RE plus R) with the remainder being other fatty acid methyl esters like methyl linoleate, methyl oleate, methyl stearate and methyl palmitate) is shown along with the percent weight of surfactant and/or solvent. Any of the surfactant/solvent combinations can be used with the fatty acid or fatty acid analogs of the invention to create nematicidal compositions.

A number of embodiments of the invention have been described. Nevertheless, it will be understood that various modifications may be made without departing from the spirit and scope of the invention. Accordingly, other embodiments are within the scope of the following claims.

1. A nematicidal composition comprising:
(a) an effective amount of a compound having the formula 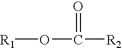
wherein:
R₁═H, a cation or a C1-C5 substituted or unsubstituted carbon chain, wherein the substituents are selected from the group consisting of: halogen, amino, cyano, cyclopropane, epoxy and a substituted or unsubstituted C1-C2 carbon chain; and
R₂=a C15-C19 substituted or unsubstituted carbon chain having a trans double bond between the 9^{th} and 10^{th} carbons counting from the carbonyl (C═O) carbon and either: (i) a triple bond between the 12^{th} and 13^{th} carbons counting from the carbonyl (C═O) carbon or (ii) either a single or double bond between the 12^{th} and 13^{th} carbons and at least one substituent at one or both of the 12^{th} and 13^{th} carbons, wherein the substituents are selected from the group consisting of hydroxy, oxo, halogen, amino, cyano, azido, cyclopropane, cyclopropene, epoxy and a substituted or unsubstituted C1-C2 carbon chain; and
(b) an aqueous surfactant.

2-84. (canceled)

85. The nematicidal composition of claim 1 wherein the C1-C2 carbon chain of R₂ is substituted and the substituents are selected from the group consisting of: hydroxy, halogen, amino, cyano, and epoxy.

86. The nematicidal composition of claim 1 wherein the C1-C2 carbon chain of R₂ is substituted and the substituents are selected from the group consisting of: hydroxy, halogen, and amino.

87. The nematicidal composition of claim 1 wherein R₂ is a C15-C19 substituted or unsubstituted carbon chain having a trans double bond between the 9^{th} and 10^{th} carbons counting from the carbonyl (C═O) carbon and either: (i) a triple bond between the 12^{th} and 13^{th} carbons counting from the carbonyl (C═O) carbon or (ii) either a single or double bond between the 12^{th} and 13^{th} carbons and at least one substituent at one or both of the 12^{th} and 13^{th} carbons, wherein the substituents are selected from the group consisting of hydroxy, oxo, halogen, amino, cyano, azido, cyclopropane, cyclopropene, epoxy and an unsubstituted C1-C2 carbon chain.

88. The nematicidal composition of claim 1 wherein the C1-C2 carbon chain of R₂ is substituted and the substituents are selected from the group consisting of: hydroxy, oxo, halogen, amino, cyano, azido, and epoxy.

89. The nematicidal composition of claim 1 wherein the C1-C2 carbon chain of R₂ is substituted and the substituents are selected from the group consisting of: hydroxy, oxo, halogen, azido, and amino.

90. The nematicidal composition of claim 1 wherein the C1-C2 carbon chain of R₂ is singly substituted.

91. The nematicidal composition of claim 1 wherein R₂ is substituted only at one or both of 12^{th} and 13^{th} carbons counting from the carbonyl (C═O) carbon.

92. The nematicidal composition of claim 91 wherein R₂ is substituted only at the 12^{th} carbon counting from the carbonyl (C═O) carbon.

93. The nematicidal composition of claim 91 wherein R₂ is substituted only at the 13^{th} carbon counting from the carbonyl (C═O) carbon.

94. The nematicidal composition of claim 91 wherein within R₂ the substituents are polar and are selected from the group consisting of: hydroxy, oxo, epoxy, halogen, amino, cyano and azido.

95. The nematicidal composition of claim 91 wherein within R₂ the substituents are hydrogen bond acceptors and are selected from the group consisting of: hydroxy, oxo, epoxy, amino, cyano and azido.

96. The nematicidal composition of claim 91 wherein within R₂ the substituents are selected from the group consisting of: hydroxy, oxo and epoxy.

97. The nematicidal composition of claim 1 wherein the aqueous surfactant is selected from the group consisting of: ethyl lactate, Span 20, Span 40, Span 80, Span 85, Tween 20, Tween 40, Tween 80, Tween 85, Triton X 100, Makon 10, Igepal CO 630, Brij 35, Brij 97, Tergitol TMN 6, Dowfax 3B2, Physan and Toximul TA 15.

98. The nematicidal composition of claim 1 wherein the composition further comprises: (c) a permeation enhancer.

99. The nematicidal composition of claim 1 where the composition further comprises:
(c) a co-solvent.

100. The nematicidal composition of claim 1 further comprising a nematicide selected from the group consisting of: avermectins, milbemycin, aldicarb, oxamyl, fenamiphos, fosthiazate and metam sodium.

101. The nematicidal composition of claim 1 further comprising an inhibitor of oxidation.

102. The nematicidal composition of claim 1 wherein R₁═H.

103. A method for control of unwanted nematodes, the method comprising administering to a vertebrate, a plant, a seed or soil a composition comprising:
(a) a compound having the formula 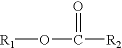
wherein:
R₁═H, and
R₂=a C15-C19 substituted or unsubstituted carbon chain having a trans double bond between the 9^{th} and 10^{th} carbons counting from the carbonyl (C═O) carbon and either: (i) a triple bond between the 12^{th} and 13^{th} carbons counting from the carbonyl (C═O) carbon or (ii) either a single or double bond between the 12^{th} and 13^{th} carbons and at least one substituent at one or both of the 12^{th} and 13^{th} carbons, wherein the substituents are selected from the group consisting of hydroxy, oxo, halogen, amino, cyano, azido, cyclopropane, cyclopropene, epoxy and a substituted or unsubstituted C1-C2 carbon chain; and
(b) an aqueous surfactant.

104. The method of claim 103 wherein the nematode infects plants and the composition is applied to the soil or to plants.

105. The method of claim 103 wherein the composition is applied to plant roots.

106. The method of claim 103 wherein the composition is applied to seeds.
